(19) United States
(12) Patent Application Publication
(10) Pub. No.: US 2015/0258940 A1
(43) Pub. Date: Sep. 17, 2015

(54) FOLDING LADDER RACK

(71) Applicant: WINSTON PRODUCTS LLC, Cleveland, OH (US)

(72) Inventors: Winston Breeden, III, Chagrin Falls, OH (US); Ryan William Chepla, Shaker Heights, OH (US); Aaron Misener, Chagrin Falls, OH (US); David Rathman, Cleveland, OH (US); David Drabousky, Twinsburg, OH (US)

(21) Appl. No.: 14/657,212

(22) Filed: Mar. 13, 2015

Related U.S. Application Data
(60) Provisional application No. 61/952,290, filed on Mar. 13, 2014.

(51) Int. Cl. B60R 9/048; B60R 9/045

(52) U.S. Cl. CPC B60R 9/0485; B60R 9/045

(57) ABSTRACT

An apparatus comprises an enclosure defining a first cavity. A rack assembly is receivable within the first cavity of the enclosure for storage. The rack assembly includes a support arm defining a second cavity. The support arm is removably connectable with the enclosure for use and receivable within the first cavity of the enclosure for storage. A beam portion is connectable with the support arm and receivable in the second cavity of the support arm for storage.

### CROSS REFERENCE TO PRIOR CO-PENDING APPLICATION

This application claims the benefit of the filing date of prior Provisional Patent Application No. 61/952,290 filed Mar. 13, 2014 and entitled Folding Ladder Rack.

### TECHNICAL FIELD

This relates generally to an accessory for vehicles. In particular, this relates to a foldable and collapsible rack that can be stored within itself and that is intended for use with a pickup truck.

### BACKGROUND

Pickup trucks are popular with sportsmen and tradesmen, such as boaters, surfers, builders, roofers, painters, plumbers, electricians and others. The pickup trucks have the ability to carry equipment, tools, material and recreational items. Many sportsmen and tradesmen equip their pickup trucks with a known rack that establishes an overhead support extending above a bed of the pickup truck. The overhead support can receive and carry items, such as ladders, pipe, lumber, small boats, canoes, surfboards and the like. Thus, the items can be carried on the rack above the bed of the pickup truck so that the bed is free for carrying and storing other items.

While known pickup truck racks have generally proven useful in increasing the carrying capacity of a pickup truck, they do have some drawbacks and disadvantages. For example, many known racks are constructed of heavy welded metal frames that are either permanently secured to the truck bed or are difficult to remove and store. Some of the known racks are collapsible and storable, but sacrifice support strength by decreasing size of parts to enable that enable storage. For example, round tubes are sized to fit side-by-side in a storage compartment of the rack.

Thus, a continuing and heretofore unaddressed need exists for a pickup truck rack adapted to satisfy the needs of sportsmen and tradesmen who use such racks while simultaneously addressing the disadvantages associated with known racks.

### SUMMARY

This summary is provided to introduce concepts in a simplified form that are further described below in the detailed description. This summary is not intended to identify key factors or essential features of the claimed subject matter, nor is it intended to be used to limit the scope of the claimed subject matter.

An apparatus, according to one aspect, comprises an enclosure defining a first cavity. A rack assembly is receivable within the first cavity of the enclosure for storage. The rack assembly includes a support arm defining a second cavity. The support arm is removably connectable with the enclosure for use and receivable within the first cavity of the enclosure for storage. A beam portion is connectable with the support arm and receivable in the second cavity of the support arm for storage.

According to another aspect, an apparatus comprises an enclosure defining a first cavity. A rack assembly is receivable within the first cavity of the enclosure for storage. The rack assembly includes a support arm defining a second cavity. The support arm is connectable with the enclosure and receivable within the first cavity of the enclosure. A beam portion is connectable with the support arm and receivable in the second cavity of the enclosure. A second beam portion is telescopically receivable within and movable relative to the beam portion.

According to yet another aspect, an apparatus comprises an enclosure defining a first cavity. A rack assembly is receivable within the first cavity of the enclosure for storage. The rack assembly includes a support arm defining a second cavity. The support arm is connectable with the enclosure and receivable within the first cavity of the enclosure. The first cavity having a first internal width and the support arm has second external width at least eighty percent of the first width. A beam portion is connectable with the support arm and receivable in the second cavity of the enclosure. Attachment structure is associated with the enclosure and located external to the first cavity of the enclosure for removable attachment of the support arm to the enclosure.

The following description and drawings set forth certain illustrative embodiments, aspects and implementations. These are indicative of but a few of the various ways in which one or more aspects can be employed. Other aspects, advantages, and novel features of the disclosure will become apparent from the detailed description below when considered with reference to the drawings.

### DESCRIPTION OF THE DRAWINGS

FIG. 1 is a perspective view of a ladder rack, according to one aspect, installed on a pickup truck bed;

FIG. 2a is an enlarged perspective view of a portion of the ladder rack illustrated in FIG. 1;

FIG. 2b is an enlarged perspective view of a portion of the ladder rack, illustrated in FIG. 2a, with parts in one position;

FIG. 2c is a view similar to FIG. 2b with parts in another position;

FIG. 3 is a perspective view of the ladder rack illustrated in FIG. 1, installed on a pickup truck bed in a stored condition;

FIGS. 4-10 illustrate, in a sequence of steps, the unfolding of the ladder rack from the condition of FIG. 3;

FIGS. 11a-11c are enlarged perspective views of attachment structure with parts in different positions and illustrating features;

FIGS. 12-15 illustrate, in a sequence of steps, the detachment of the ladder rack from the attachment structure of FIGS. 11a-11c;

FIG. 16 is a perspective view of the ladder rack of FIG. 1, installed on a pickup truck bed in a stored condition, and showing a tie down receiver feature;

FIG. 17 is an enlarged perspective view of the tie down receiver feature illustrated FIG. 16;

FIG. 18 an enlarged perspective view of a portion of the ladder rack showing another tie down receiver feature;

FIG. 19 is an enlarged cross-sectional view of an enclosure of the ladder rack;

FIG. 20 is a perspective view of a ladder rack, according to another aspect, installed on a pickup truck bed;

FIG. 21 is an enlarged perspective view of a portion of the ladder rack illustrated in FIG. 20; and

FIGS. 22-35 illustrate connector mechanisms of the ladder rack in respective released and connected positions, according to various alternate aspects.

### DETAILED DESCRIPTION

The claimed subject matter is described with reference to the drawings, in which like reference numerals are generally used to refer to like elements throughout. In the following description, for purposes of explanation, numerous specific details are set forth in order to provide an understanding of the claimed subject matter. It will be apparent, however, that the claimed subject matter can be practiced without these specific details.

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

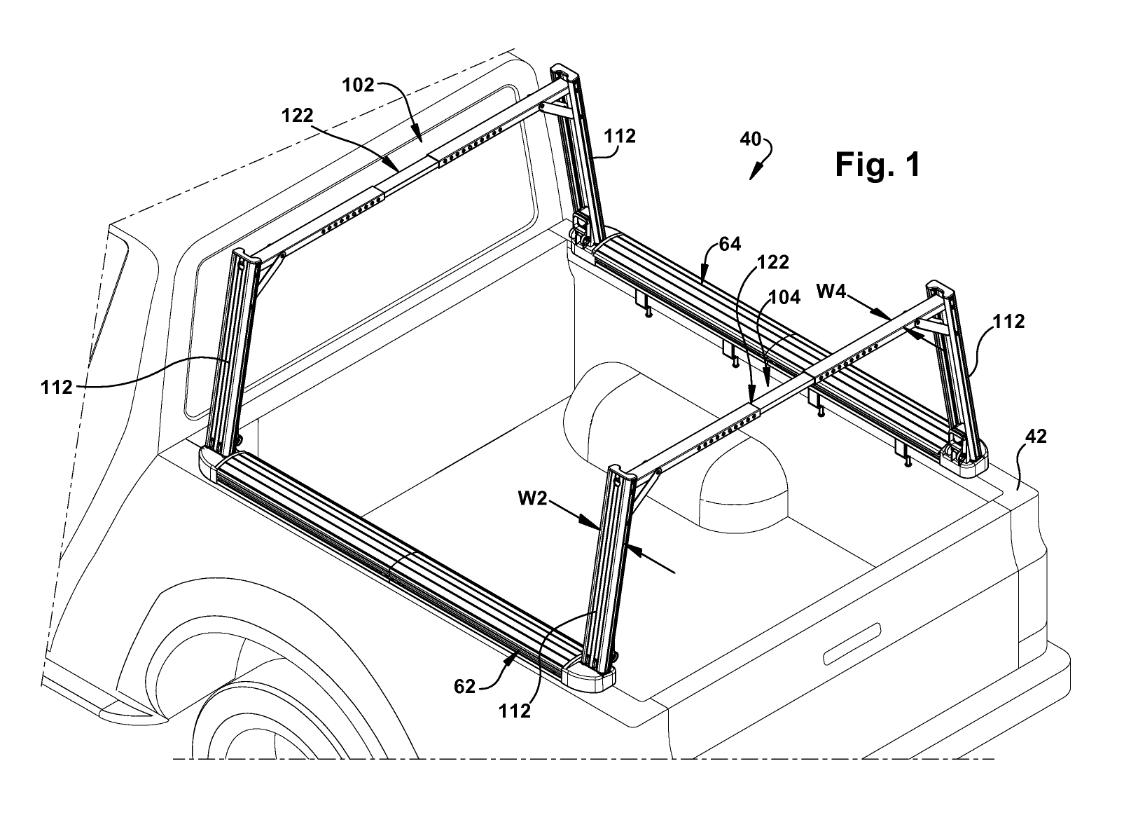

A ladder rack assembly 40, according to one aspect, is illustrated in FIG. 1. In general, the ladder rack assembly 40 can be used in association with a vehicle 42, such as a pickup truck (as illustrated), car, trailer or the like. The ladder rack assembly 40 is illustrated in FIG. 1 in its unfolded and deployed condition. During deployment, the ladder rack assembly 40 can, for example, support one or more items thereon, such as equipment, tools, material and recreational items. The ladder rack assembly 40, as will be described below, can also be selectively folded and stowed within itself when not deployed for use.

The ladder rack assembly 40 includes a first enclosure 62 and a second enclosure 64. The first enclosure 62 and second enclosure 64 are elongate and attachable to the vehicle 42, preferably on a substantially permanent basis, to extend in a direction parallel to a longitudinal central axis of the vehicle 42. Such attachment can be done by any suitable means, such as by fasteners, clamps, adhesives or brazing/welding.

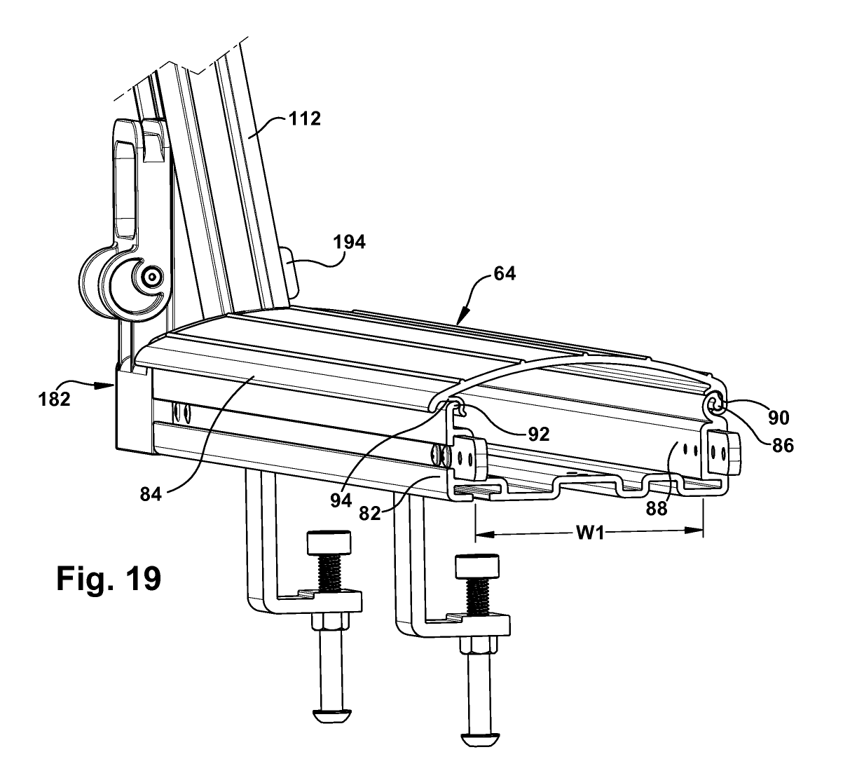

Each of the enclosures 62, 64 (only the second closure 64, illustrated in FIG. 19, is described in detail here but will suffice for the mirror image first enclosure 62 as well) includes a base 82 that is attachable to a component of the vehicle 42, such as a bed of a pickup truck. A cover 84 is attached to the base 82 by a hinge 86. The cover 84 preferably extends for substantially the entire length of the respective enclosure 62, 64. However, it will be apparent that the cover 84 may be made up of more than one cover portions. The base 82 is channel shaped and defines a cavity 88 that has an internal dimension or width W1 extending transversely to the length of the base of the enclosures 62, 64. The hinge 86 is illustrated as located to the outside of the vehicle 42, but it will be apparent that the hinge could equally be located to the inside of the vehicle.

The cover 84 on a respective enclosure 62, 64 may be pivoted about the hinge 86 between a closed and open position. When the cover 84 is in the closed position relative to the base 82 it protects other components of the ladder rack assembly 40 that may be stored with in the cavity 88 from environmental conditions. The cover 84 can be moved to the open position relative to the base 82 to permit access to other components of the ladder rack assembly 40 that may be stored with in the cavity 88. The base 82 and cover 84 may be made from any suitable material and by any suitable method, such as extruded metal (e.g., steel, aluminum, titanium, etc.), molded or extruded plastic, fiber reinforced plastic, and the like.

The cover 84 of the enclosure 64 allows for water to drain along the sides of the cover, such that the interior or cavity 88 of the enclosure may remain relatively free from moisture and debris. The hinge 86 is integrally formed as one piece with the base 82 of the enclosure 64. A hinge pocket 90 is integrally formed in the cover 84 and shaped to accept the hinge 86. In some examples, the cover 84 of the enclosure 64 is aluminum and formed and located to limit/prevent water, dirt, and other debris from entering the hinge 86. One benefit of such a design is to improve the performance and extend the life of the enclosure 64, cover 84, hinge 86, components stored within the enclosure, etc. The enclosure also has a lip 92 formed in a side of the base 82 opposite the hinge 86. A snap pocket 92 is formed in a side of the cover 84 to receive and end of the lip 90 to help retain the cover in a closed condition relative to the base 82. Locking structure may be provided to secure the enclosure 64.

The ladder rack assembly 40 (FIG. 1) also includes at least a first rack portion 102 and a substantially identical second rack portion 104. In the illustrated example, the rack portions 102, 104 are spaced apart and separated from each other in a direction along the length of the enclosures 62, 64. The rack portions 102, 104 are located and removably attached at end portions to the enclosures 62, 64. The locations of the rack portions 102, 104 on the enclosures 62, 64 are not limited to the illustrated locations and, instead, may be positioned closer together or farther apart than as illustrated. The rack portions 102, 104 are generally identical in size, shape, structure, construction, materials, etc., such that the following description of an example rack portion generally includes the first rack portion 102 or the second rack portion 104. The rack portions 102, 104 may be made from any suitable material and by any suitable method, such as extruded metal (e.g., steel, aluminum, titanium, etc.), molded or extruded plastic or fiber reinforced plastic, and the like.

Each of the rack portions 102, 104 includes one or more elongated support arms 112. Each of the support arms 112 is removably attachable to a respective one of the enclosures 62, 64. The support arms 112 can be arranged to extend substantially vertically from the vehicle 42, or at a relatively small angle relative to vertical. In the illustrated example, the rack portions 102, 104 each include a pair of substantially identical support arms that are spaced apart from each other and extend in a direction transversely upright when attached to the enclosures 62, 64.

Each of the support arms 112 has an external width W2 taken in a direction transversely to the extent of the support arm. The width W2 of the support arms 112 is larger than the thickness, taken in a direction perpendicular to the width W2. The width W2 of the support arm 112 is less than the width W1 of the enclosures 62, 64, and preferably at least over half the width W1 and more preferably at least seventy percent of width W1. Thus, the support arms 112 are sufficiently rigid/sturdy so as to provide an increased and improved sufficient amount of support for items on the rack portions 102, 104 and not require bracing reinforcement between support arms attached to the same enclosure 62, 64. The support arms 112 may also be nested and stowed within the enclosures 62, 64. The support arm 112 is channel shaped (with a bight portion being larger than the legs extending therefrom) and defines a cavity 114 having an internal width W3. Each support arm 112 may be made from any suitable material and by any suitable method, such as extruded metal (e.g., steel, aluminum, titanium, etc.), molded or extruded plastic, fiber reinforced plastic, and the like.

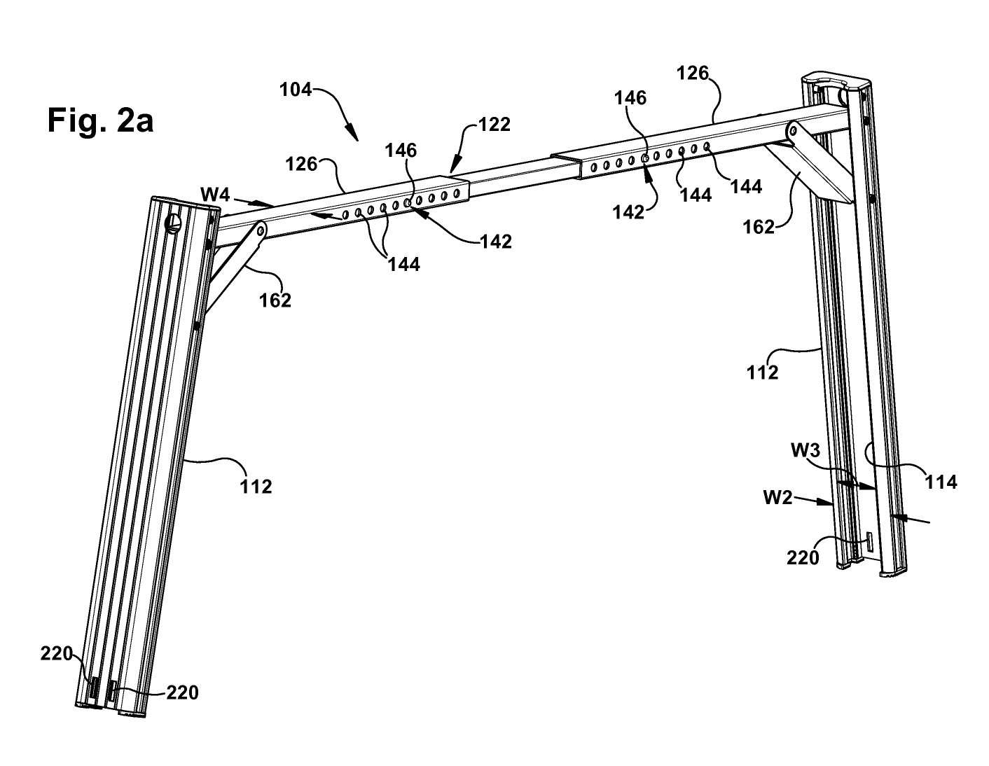

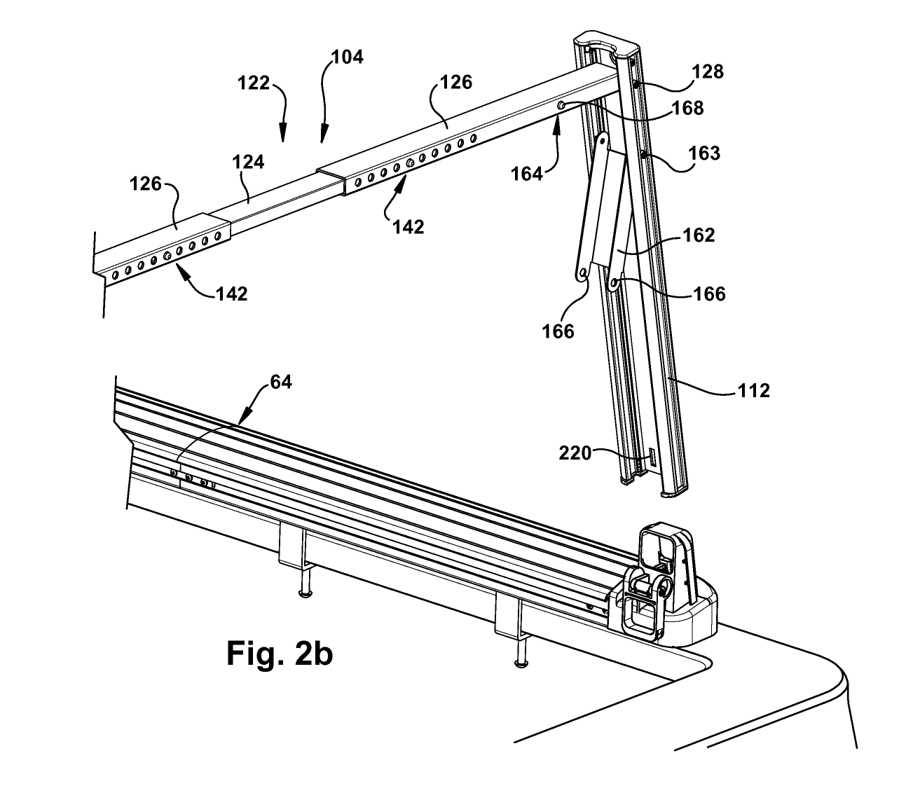

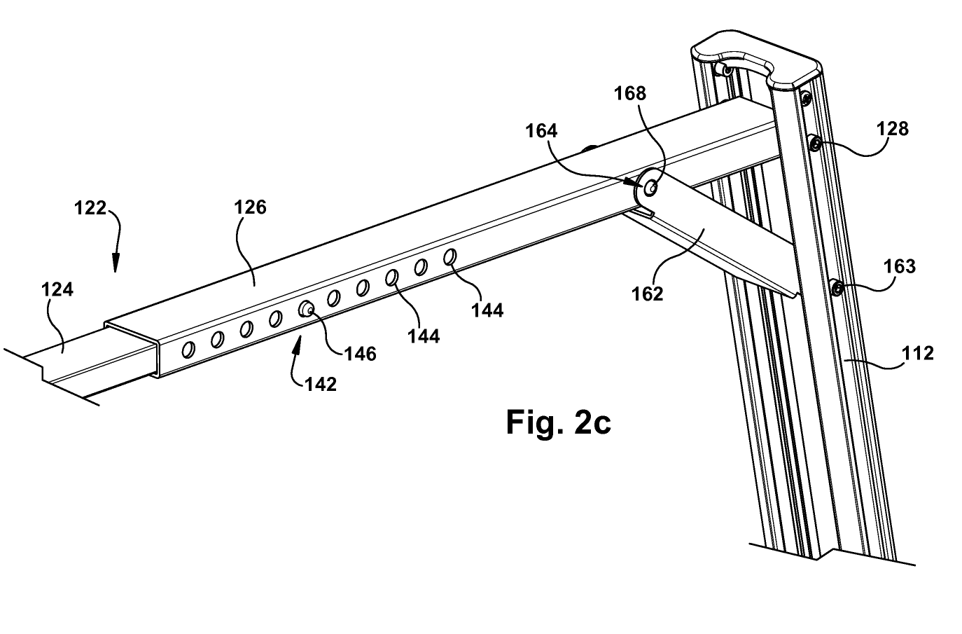

The rack portions 102, 104 (FIGS. 2a-2c,) each include an elongated attachment beam 122. The attachment beam 122 extends between a pair of respective opposing support arms 112 attached to different enclosures 62, 64. The support arms 112 preferably have a length the will locate the attachment beams 122 at a height that is equal to or greater than the height of the cab of the vehicle 42. The attachment beam 122 is intended to extend in a generally horizontal orientation, when the ladder rack assembly 40 is assembled and installed on the vehicle 42, though other orientations/angles/directions are envisioned.

The attachment beam 122 is preferably a rectangular tube. The attachment beam 122 is attached to/supported at an end (e.g., upper ends) of the support arms 112 for pivotal movement. In particular, the support arms 112 can attach to/support the attachment beam 122 at an upper end, as viewed in FIG. 2a, while a lower end of the support arm 112 is attached to a respective one of the enclosure 62, 64. The attachment beam 122 has an external width W4 that is smaller than the internal width W3 of the cavity 114 in support arm 112. Thus, the attachment beam 122 can pivot into the cavity 114 in support arm 112 in a nesting manner for storage. The entire structure of the nested attachment beam 122 in the support arm 112 can be stored in the enclosure 62, 64 when the ladder rack assembly 40 is not deployed. The width W4 of the attachment beam 122 is larger than the thickness, taken in a direction perpendicular to the width W4.

In the illustrated example, the attachment beam 122 includes several different portions, for example three portions. The attachment beam 122 includes a center beam portion 124. The center beam portion 124 extends partially or completely between a pair of support arms 112. The center beam portion 124 can be attached to one or more adjustable beam end portions 126. In this example, the adjustable beam portions 126 are located on opposing sides of the center beam portion 124. The adjustable beam end portions 126 are attached for pivotal movement at one end to the respective support arms 112 and at an opposing end to the center beam portion 124 by suitable structure 128, such as fasteners or rivets.

The adjustable beam portions 126 and the center beam portion 124 are releasable and adjustably attached relative to one another in any number of ways. For example, the adjustable beam portions 126 and center beam portion 124 can be telescopically attached, such that the adjustable beam portions and center beam portion can move with respect to each other. In the illustrated example, the adjustable beam portions 126 telescopically receive the center beam portion 124. In other examples, however, the center beam portion 124 can telescopically receive the adjustable beam portions 126. The center beam portion 124 and the adjustable beam portions 126 may be made from any suitable material and by any suitable method, such as tubular metal (e.g., steel, aluminum, titanium, etc.), molded or extruded plastic, fiber reinforced plastic, and the like. The center beam portion 124 has a length that is selected to fit substantially entirely within the adjustable beam portions 126 for storage.

The adjustable beam portions 126 and center beam portion 124 are releasable and movably adjustable by respective quick release connector structure 142. In the illustrated example, the adjustable beam portions 126 include adjustment openings 144 that extend at least partially along a length of the adjustable beam portions. The center beam portion 124 includes at least one spring loaded protrusion 146 that is transversally movable (e.g., can be pushed in and biased outwardly). The protrusion 146 is sized/shaped to be received within one of the adjustment openings 144 of the adjustable beam portions 126.

In operation, the protrusion 146 is received within the desired adjustment openings 144 of the adjustable beam portions 126, such that the adjustable beam portions and center beam portion 124 are substantially non-movable with respect to each other. However, to adjust the relative positions of the adjustable beam portions 126 with respect to the center beam portion 124, the protrusion 146 can be pushed or flexed inwardly (e.g., so as to disengage from the adjustment openings 144), with the center beam portion being moved with respect to the adjustable beam portions to establish a desired length of each attachment beam 122.

The rack portions 102, 104 each include one or more movable arms or support brackets 162. The support brackets 162 are attached for pivotal movement at one end, the lower end as viewed in FIGS. 2a-2c, to the respective support arm 112. The support brackets 162 are attached for pivotal movement to the respective support arm 112 by suitable structure 163, such as fasteners or rivets. The support brackets 162 are also removably attached at an opposite end, the upper end as viewed in FIGS. 2a-2c, to the to the adjustable beam portions 126. The support brackets 162 provide additional support to the attachment beam 122. In this example, the support brackets 162 can be selectively attached/detached to the adjustable beam portions 126, such that the support brackets can be selectively stowed. The support brackets 162 are sized and shaped, so that they fit or nest between the inside of the support arm 112 and the outside of the adjustable beam portion 126 for compact storage.

The support brackets 162 can be releasably attached in any number of ways to the adjustable beam portions 126, such as by mechanical fasteners, locking means, or the like. In the illustrated example, the support brackets 162 are releasably attached to the adjustable beam portions 126 by respective quick release connector structure 164. The support brackets 162 include openings 166. The support brackets 162 include at least one spring loaded protrusion 168 that is transversally movable (e.g., can be pushed in and biased outwardly). The protrusion 168 is sized/shaped to be received within the opening 166 of each support bracket 162.

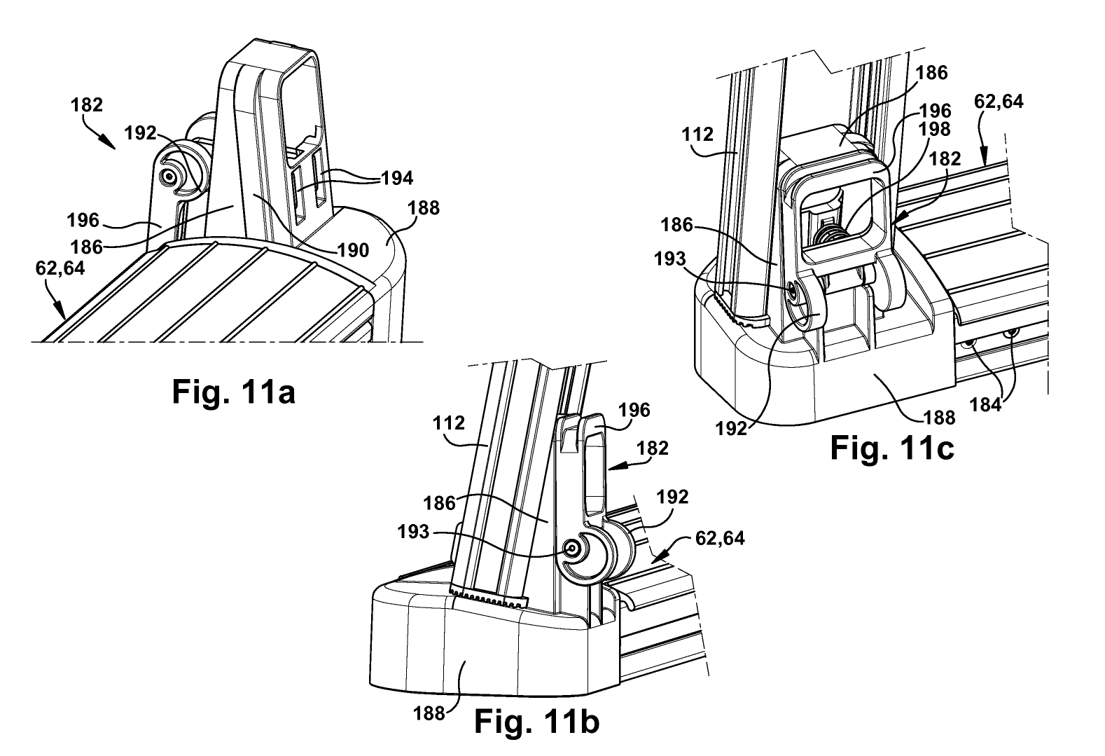

Each of the closures 62, 64 includes a pair of suitable attachment structures 182, illustrated in FIGS. 11a to 11c, at opposite end portions of the enclosures. Each of the attachment structures 182 is generally identical, such that only one of the attachment structures needs to be illustrated and described. The attachment structure 182 is fixed to the base 82 of the closure 62 or 64 by suitable mounting structure 184, such as fasteners or rivets.

The attachment structure 182 includes an extension portion 186. The extension portion 186 projects outwardly (e.g., vertically or upwardly, as viewed in FIGS. 11a to 11c) from a mounting portion 188. The extension portion 186 includes a track 190 that extends along the extension portion 186. In an example, the extension portion 186 can be received within the cavity 114 of the support arm 112. The track 190 receives and engages sides of the support arm 112 so as to assist in guiding and attaching the support arm to the attachment structure 182.

The attachment structure 182 also includes a cam 192. The cam 192 is movable about an axis 193 (e.g., a screw, pin, etc.) The cam 192 is operatively attached (e.g., directly or indirectly attached) to one or more tabs 194. The tabs 194 movably extend outwardly from the extension portion 186 on an opposite side of the extension portion 186 from the cam 192.

The cam 192 includes a handle 196 for moving the cam movable about the axis 193. While the attachment structure 182 includes any number of constructions, in this example, the attachment structure includes a spring 198 (FIG. 11c) that biases the cam 192 and tabs 194 to a closed, retracted, non-extended position. The spring 198 has sufficient force to maintain the tabs 194 in this non-extended position until the cam 192 and handle 196 are rotated, which overcomes the bias of the spring 198 to cause the tabs 194 to extend outwardly from the extension portion 186.

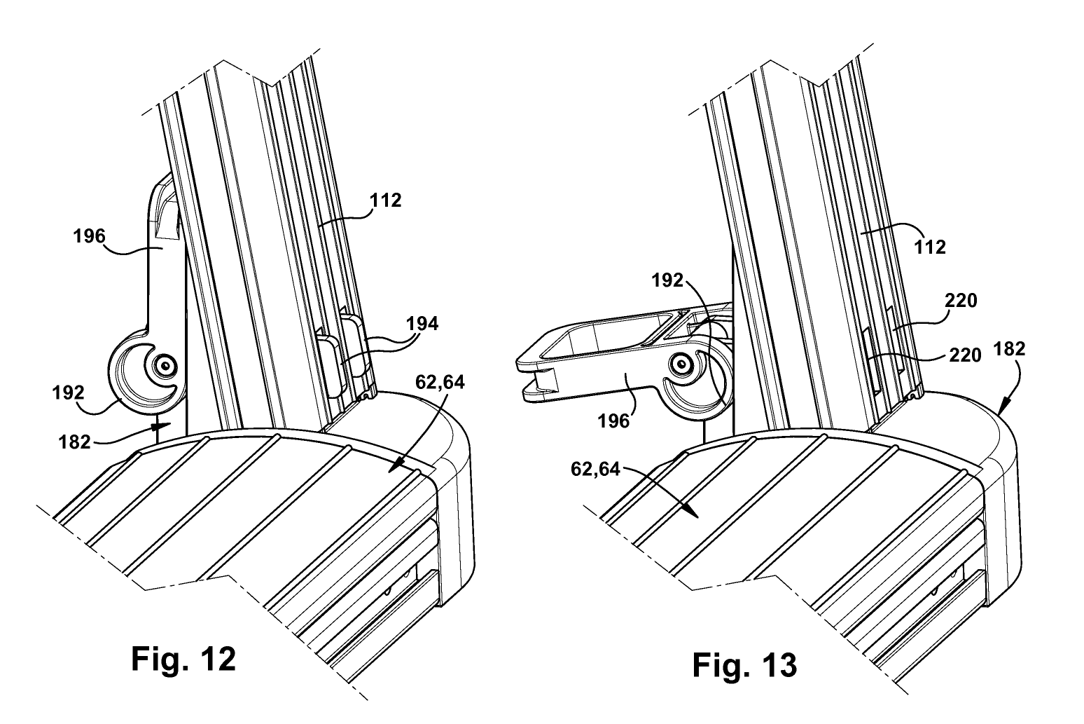

The handle 196 can be pivoted between a first position (as illustrated in FIG. 11a) and a second position (illustrated in FIGS. 11b and 12). In the first position (FIGS. 11a to 11c), the handle 196 points downwardly, as viewed in FIG. 11a, with the tabs 194 generally retracted into and not extending outwardly from the extension portion 186. The handle 196 can be moved into the second position (illustrated in FIG. 12) by rotating and pointing upwardly. In this second position, the tabs 194 extend outwardly from the extension portion 186.

The support arm 112, as illustrated in FIG. 12, is positioned to receive the attachment structure 182. The support arm 112 includes one or more (e.g., two) openings 220 (FIGS. 2a and 2b) that are sized/shaped to receive the tabs 194. Once the support arm 112 is positioned on/over the attachment structure 182, the handle 194 can be pivoted upwardly to the second position such that the tabs 194 engage and extend into the openings 220 in the support arm. As such, the support arm 112 is generally limited/prevented from being inadvertently removed from the attachment structure 182.

The handle 196 is illustrated as moving from the second position to the first position in FIG. 13. The handle 196 can be moved from the second (locked) position to the first (unlocked) position so as to allow for the support arm 112 to be unlocked and removed from the attachment structure 182. The handle 196 can be pivoted downwardly, which causes the tabs 194 to retract and move (e.g., move left) out of the openings 220 in the support arm 112. This unlocks the support arm 112 from the attachment structure 182 and allows removal of the support arm and attachment beam 122 from the enclosure 62 or 64.

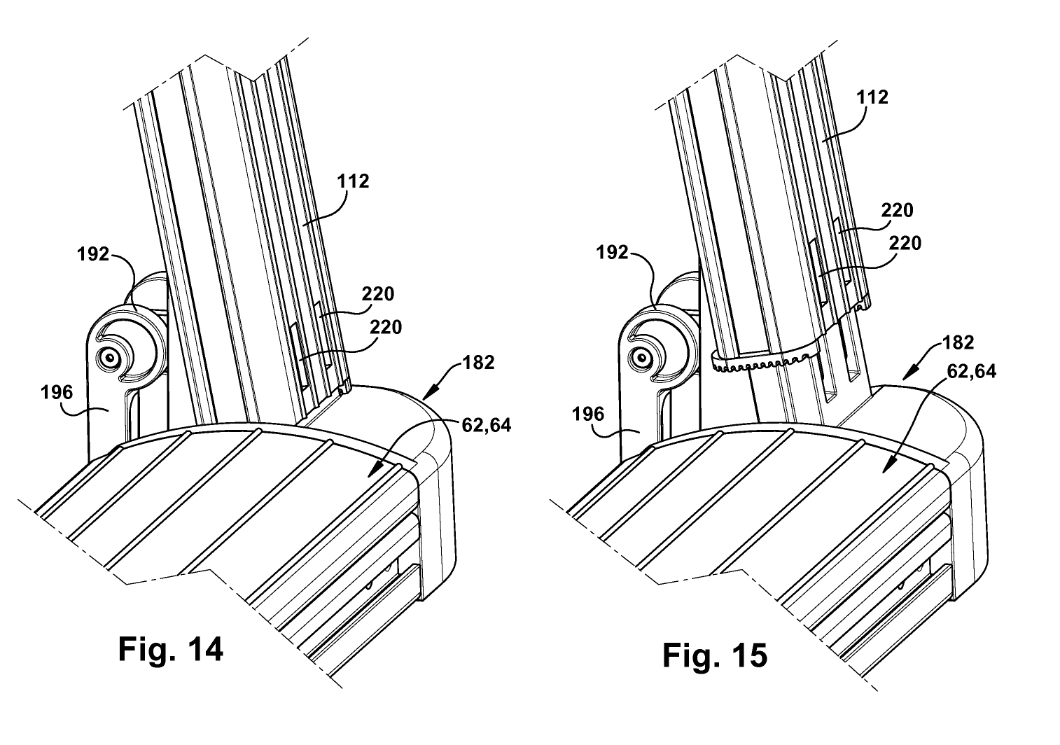

The handle 196 is illustrated in FIG. 14 in the first position. As illustrated, the tabs 194 are fully retracted, such that the tabs do not extend into the openings 220 in the support arm 112. In particular, due to the geometry of the cam 192 and a cam engaging an engagement end portion (not shown) of the tabs 194, that are supported for reciprocal movement within the extension portion 186 of the attachment structure 182, the tabs can move from the extended position (FIG. 12) to the retracted position (FIG. 14). In this position, the support arm 112 is free to be detached and removed from the attachment structure 182. As illustrated in FIG. 15, the support arm 112 can be freely removed from the attachment structure 182 by being raised in a substantially vertical direction off of the extension portion 186.

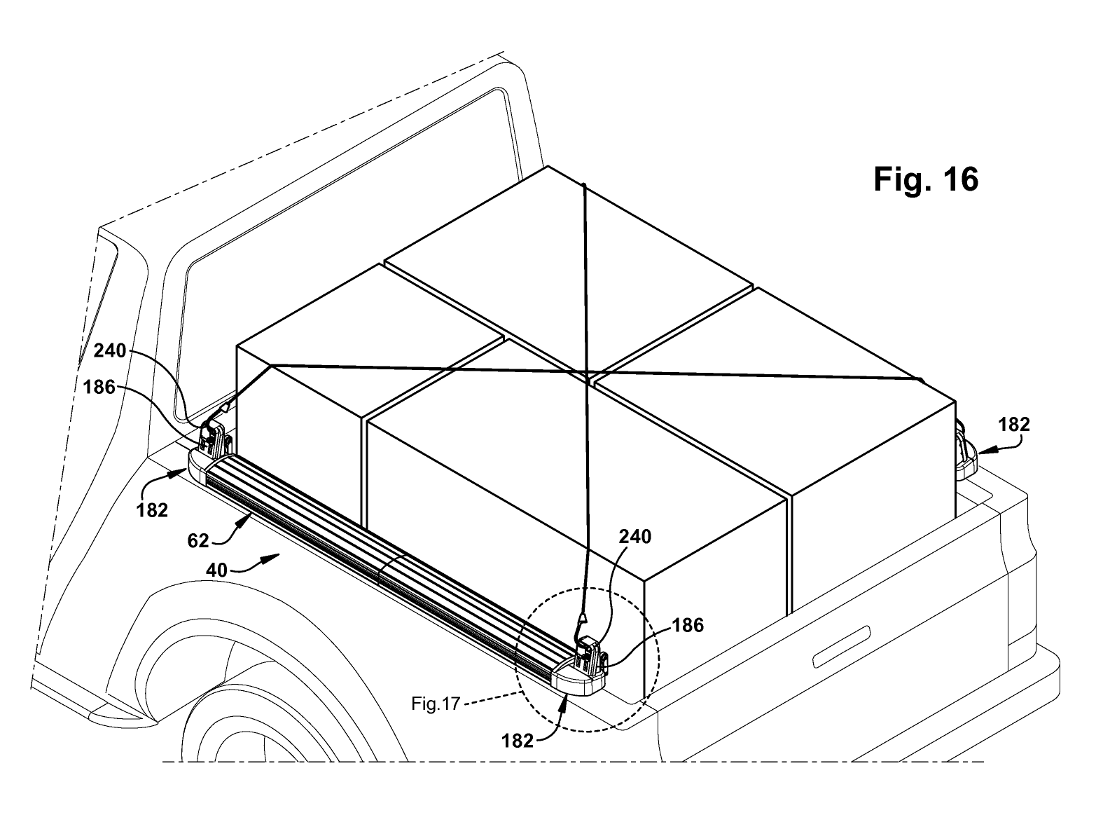

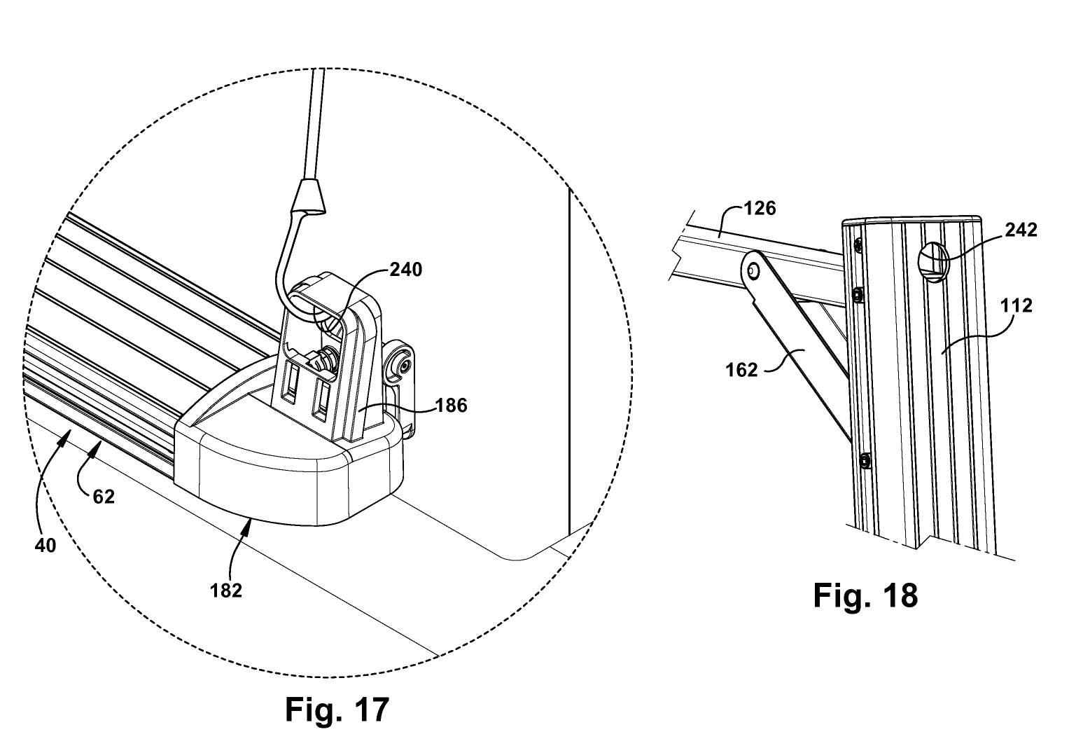

The attachment structure 182 (FIGS. 16 and 17) can include a hollow channel or opening 240 that extends through the attachment structure. The opening 240 serves as a tie-down feature that allows for removable attachment of connecting structures or hooks (as illustrated), ties, grips, ropes, straps or the like.

One or more of the support arms 112 may include an opening 242 (FIG. 18). In this example, the opening 242 is located at an end portion of the support arm 112 adjacent the attachment beam. The opening 242 in the support arm 112 allows for attachment of connecting structures or hooks (as illustrated), ties, grips, ropes, straps or the like to be removably attached to the support arms through the opening.

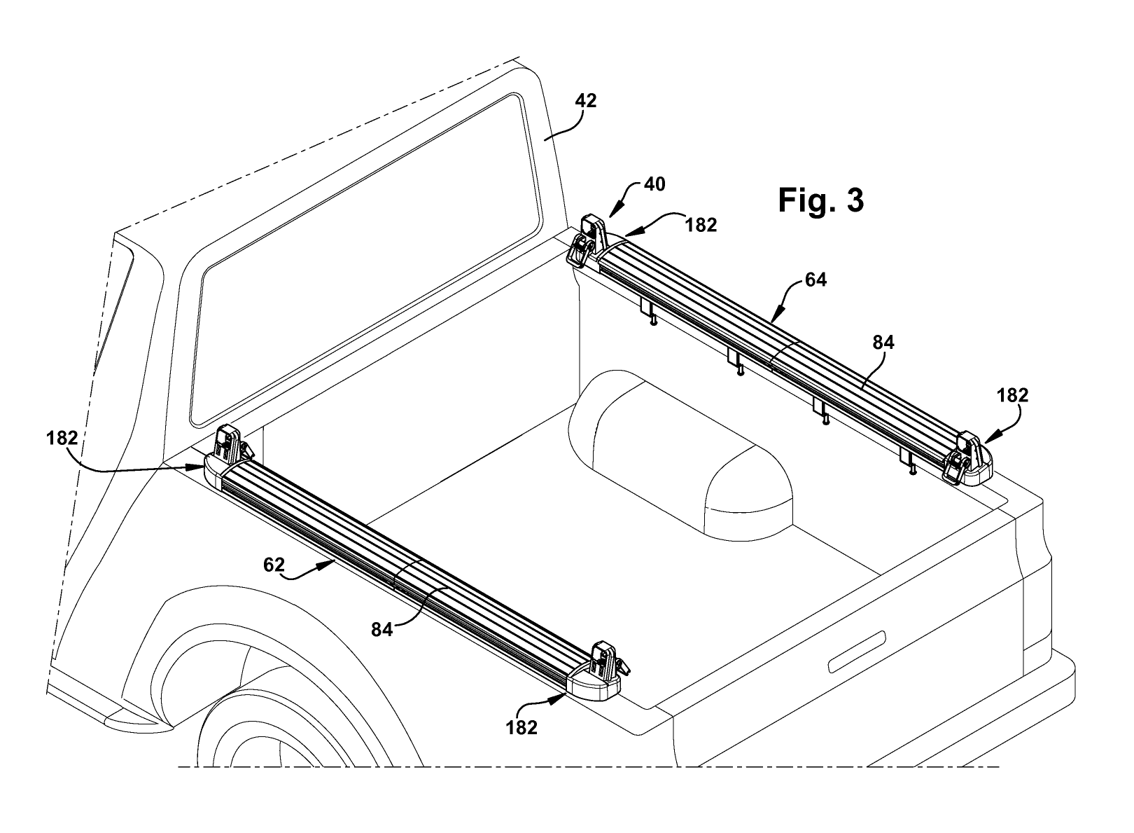

An example assembly, installation deployment and operation of the ladder rack assembly 40 is described below and illustrated in FIGS. 3-10. Initially, the first rack portion 102 and second rack portion 104 are stowed/stored, as illustrated in FIG. 3. For example, the first rack portion 102 is be stowed/stored in the first enclosure 62 while the second rack portion 104 is stowed/stored in the second enclosure 64. In the stored condition, the vehicle 42 can be driven with little or no the risk of the ladder rack assembly 40 becoming detached from the vehicle, being stolen, etc.

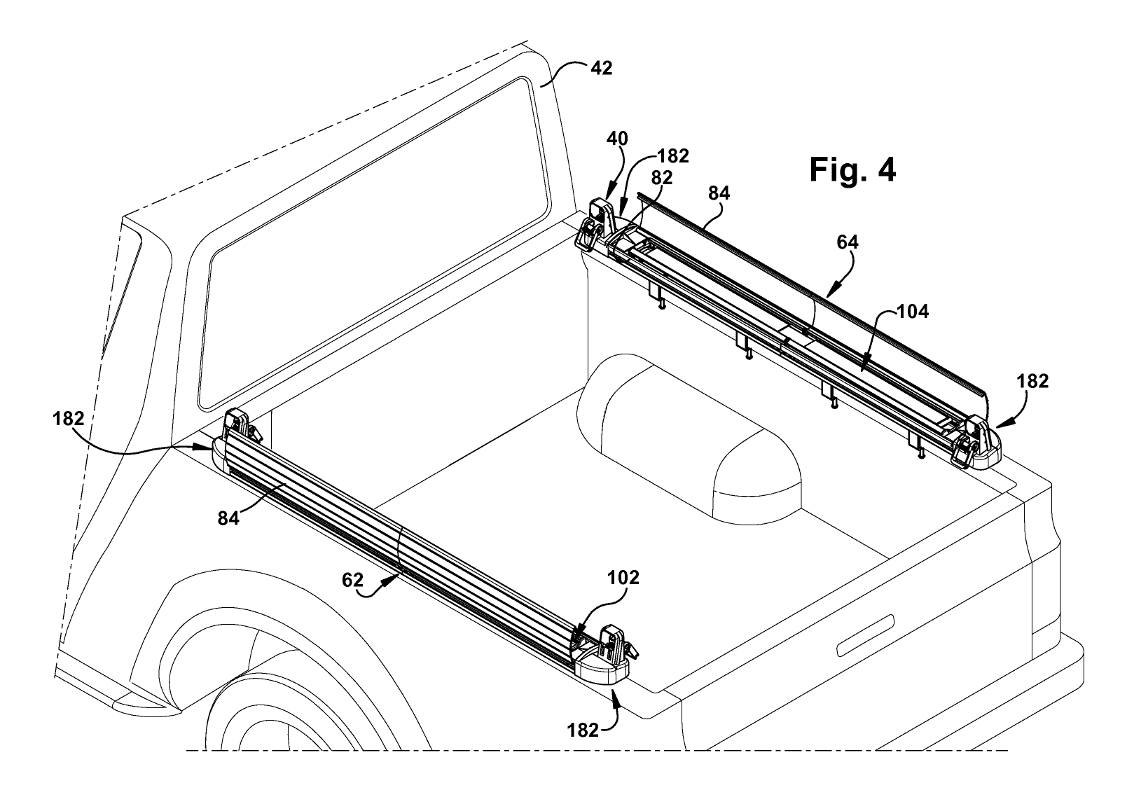

The enclosures 62, 64 are opened to access the respective rack portions 102, 104, as illustrated in FIG. 4. The cover 84 on the enclosure 62 is opened (e.g., designated by arrows) to access the first rack portion 102. Likewise, the cover 84 on the second enclosure 64 is opened (e.g., designated by arrows) to access the second rack portion 104.

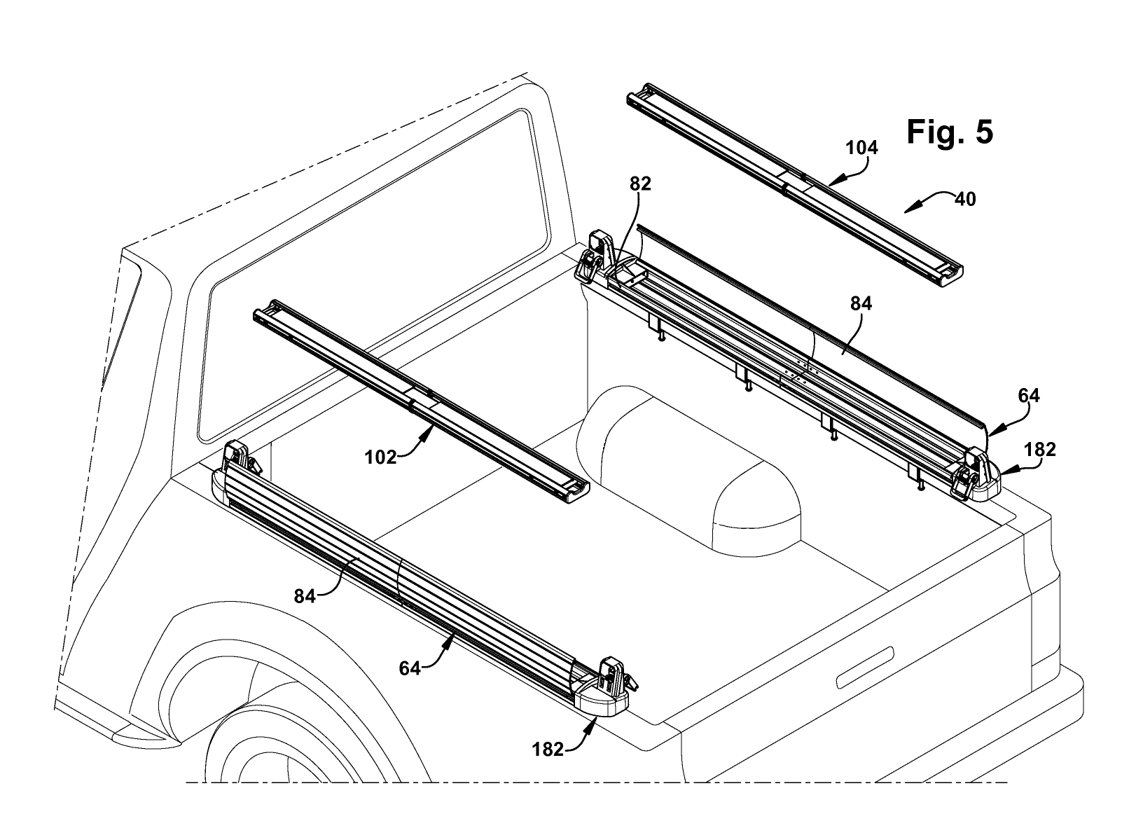

The rack portions 102, 104 are removed from the respective enclosures 62, 64, as illustrated in FIG. 5. In particular, the first rack portion 102 is removed (e.g., designated by arrows) by being vertically lifted out of the first enclosure 62. Likewise, the second rack portion 104 is removed (e.g., designated by arrows) by being vertically lifted out of the second enclosure 64.

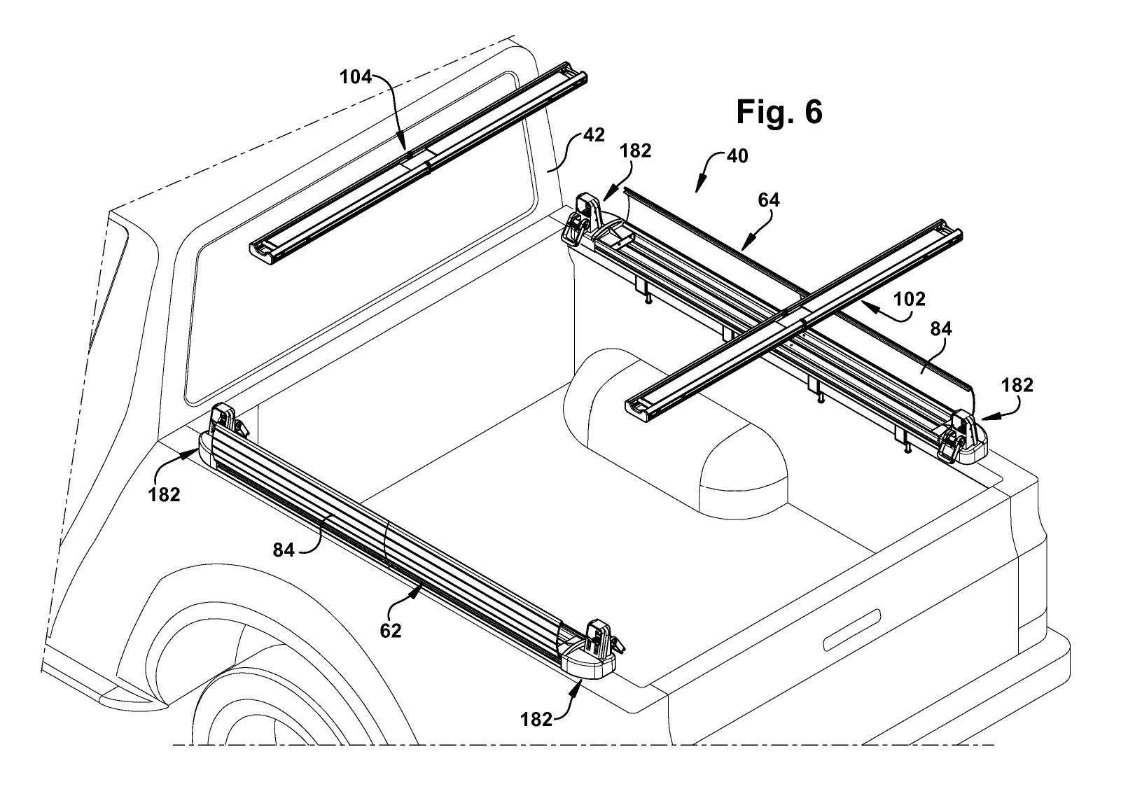

The rack portions 102, 104 are now moved/oriented, as illustrated in FIG. 6, to a pre-attachment position for assembly into a useable structure. In particular, the first rack portion 102 is moved (e.g., designated by arrows) so as to extend across the rear portion of the bed of the vehicle 42 between the two enclosures 62, 64. Similarly, the second rack portion 104 is moved (e.g., designated by arrows) so as to extend across the front portion of the bed of the vehicle 42 between the two enclosures 62, 64. It will be apparent that the relative forward and rearward positions of the rack portions 102, 104 are interchangeable. In this example, the first rack portion 102 and the second rack portion 104 are generally spaced apart from each other in the direction that the enclosures 62, 62 extend.

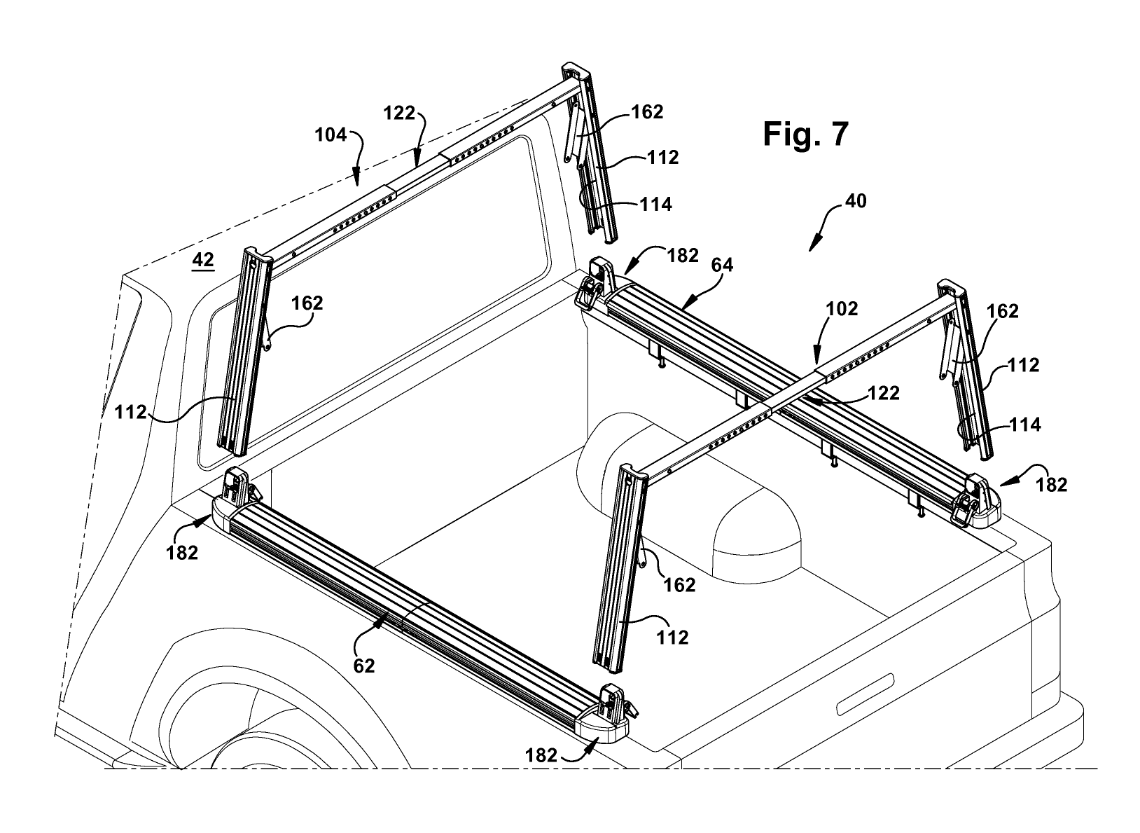

The support arms 112 are moved into an opened position/configuration relative to the respective attachment beams 122, as illustrated in FIG. 7. For example, with respect to either of the first rack portion 102 or second rack portion 104, the support arms 112 are moved/pivoted downwardly (e.g., designated by arrows) from the stored condition into an extended position. As the support arms 112 are moved/pivoted, the attachment beams 122 exit/leave the cavities 114 of the support arms.

The attachment beam 122 can be selectively adjusted in length so as to match a desired width (e.g., distance) across the vehicle (e.g., bed). In particular, the attachment beam 122 can be lengthened or shortened such that the support arms 112 are generally aligned with sides of the vehicle bed. To adjust the length of the attachment beam 122, the protrusions 146 from the center beam portion 124 can be adjusted with respect to the adjustment openings 144 of the adjustable beam portions 126.

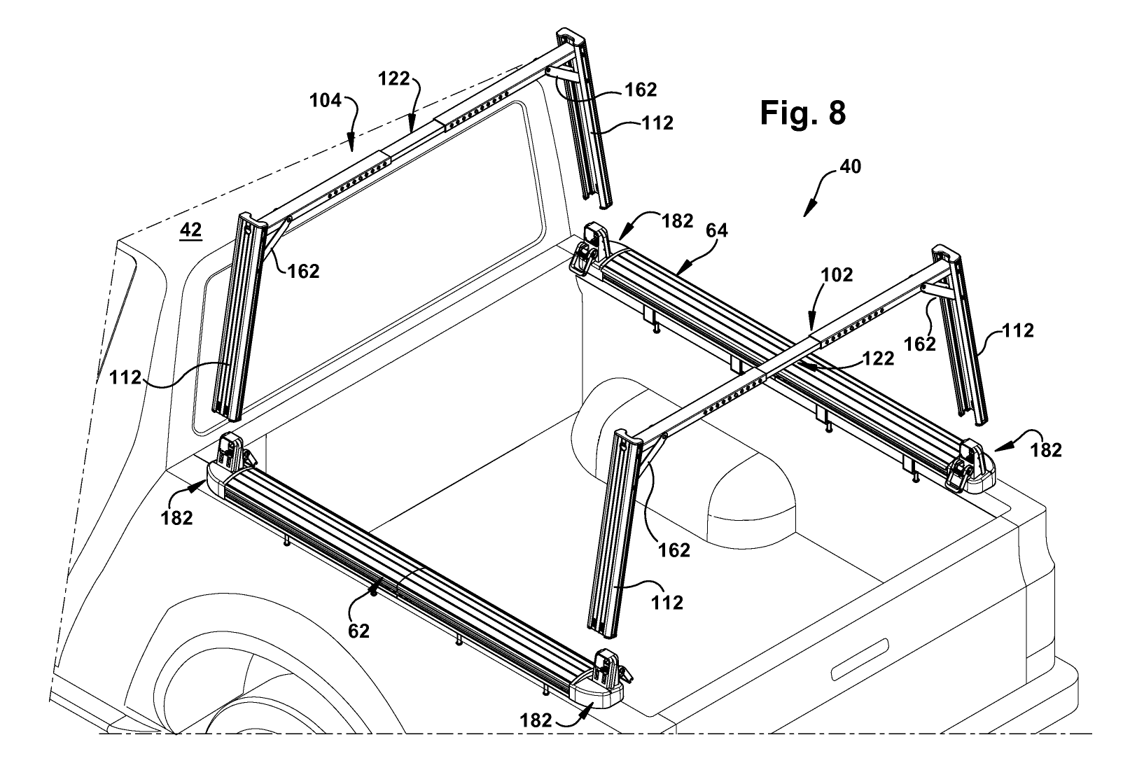

The support brackets 162 are moved upwardly (as illustrated in FIGS. 2a-2c) so as to engage the attachment beam 122 to the conditions illustrated in FIG. 8. For example, end portions of the support brackets 162 are pivoted upwardly with respect to the support arms 112 in a direction towards the adjustable beam portions 126 of the attachment beam 122. Each of the support brackets 162 are attached with respect to the adjustable beam portion 126. The support brackets 162, therefore, provide additional support to the attachment beam 122 so as to provide stability to the attachment beam and/or to allow the attachment beam to support a relatively heavier load.

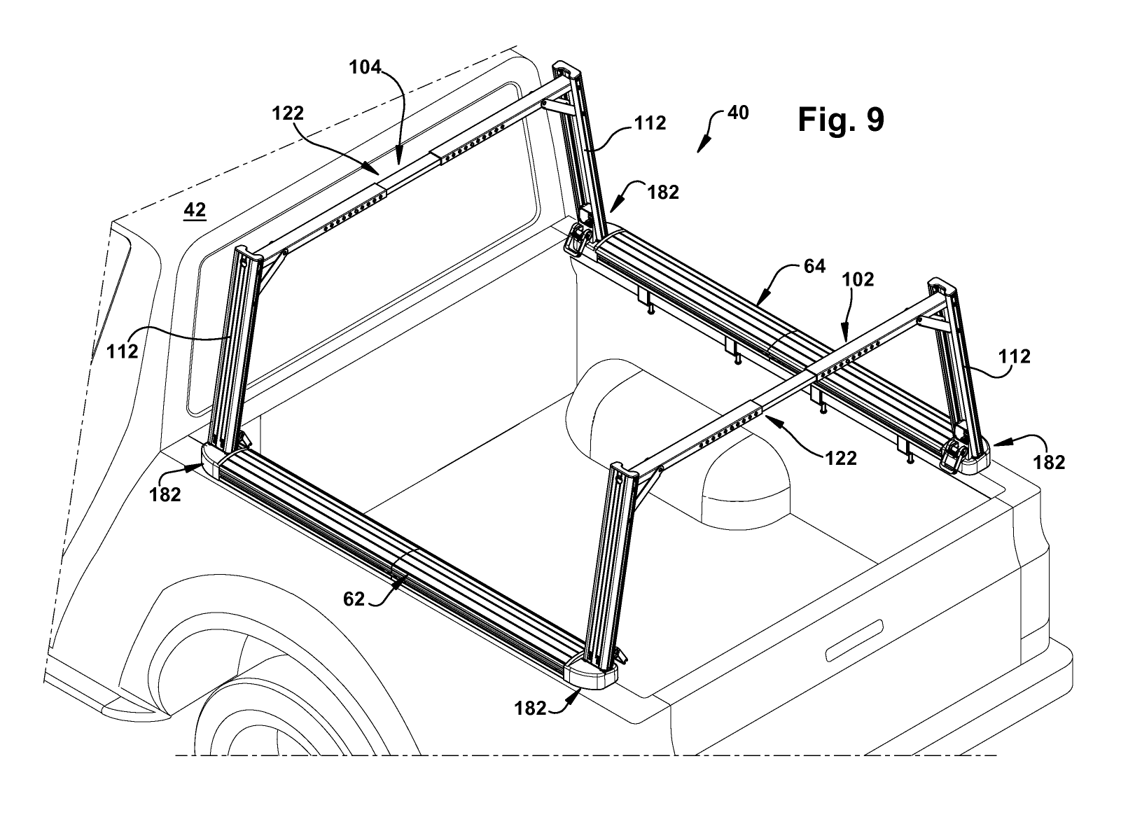

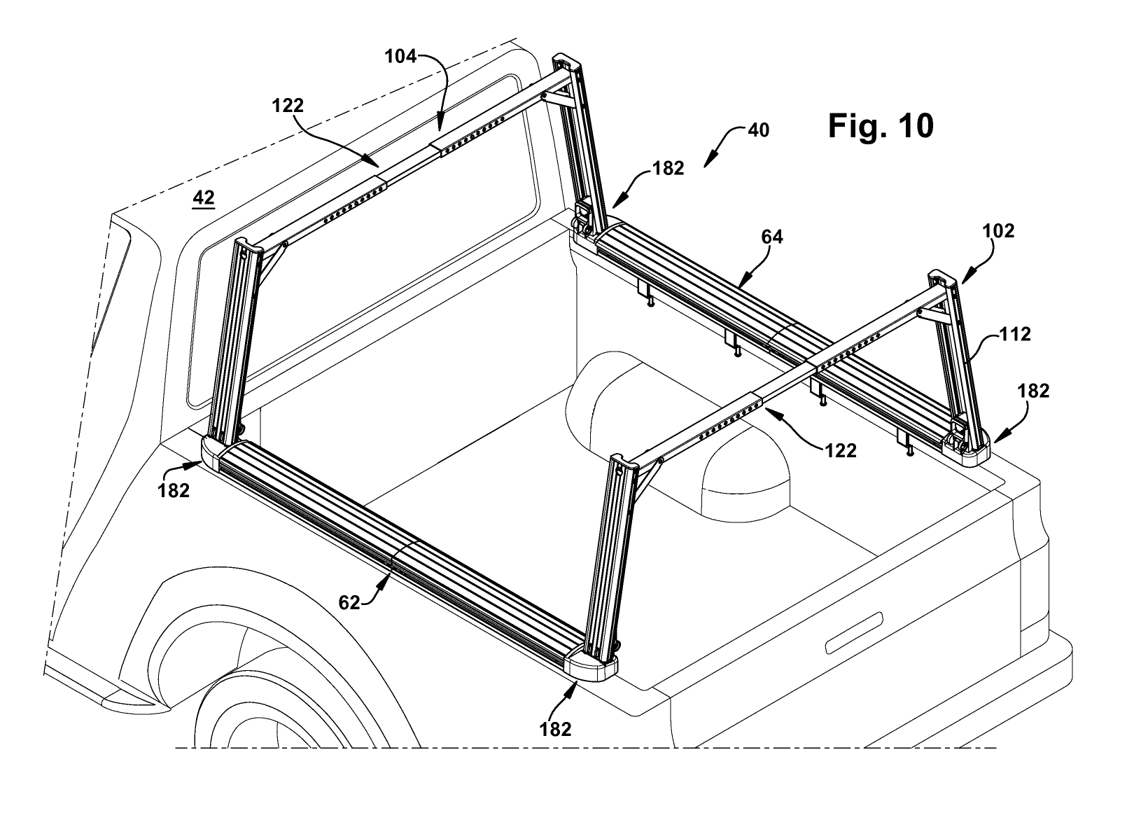

The first rack portion 102 and second rack portion 104 are attached to attachment structures 182 of the enclosures 62, 64, as illustrated in FIGS. 9-10. In this example, there are a total of four attachment structures 182, with one attachment structure positioned at each end of the respective enclosures 62, 64. The first rack portion 102 and second rack portion 104 are lowered into engagement with the attachment structures 182, such that the rack portions securely attached to the attachment structures of the enclosures 62, 64. When the rack portions 102, 104 are no longer needed for use, the ladder rack assembly 40 can be disassembled in a generally identical, but reverse order as described above.

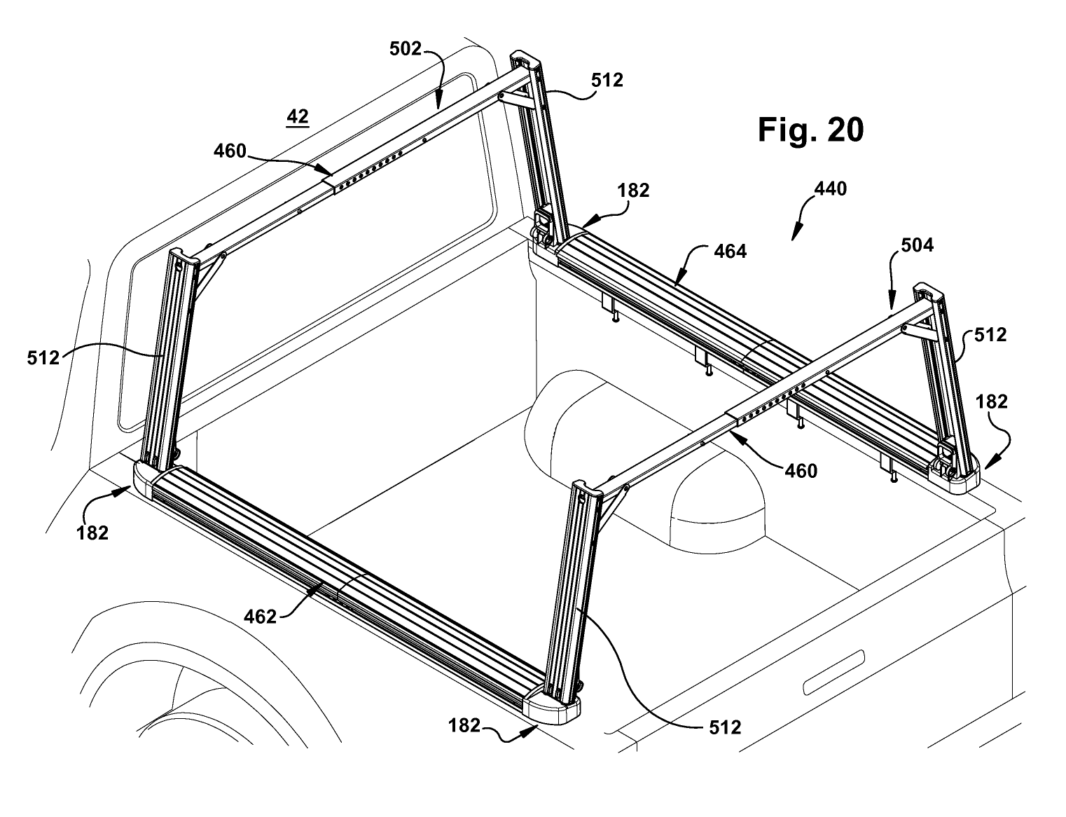

A ladder rack assembly 440, according to another aspect, is illustrated in FIG. 20. The ladder rack assembly 440 can be used in association with the vehicle 42, such as a truck (as illustrated), car, trailer or the like. The ladder rack assembly 440 is similar in design and operation to the ladder rack assembly 40 illustrated in FIG. 1 when in assembled and deployed for use. When assembled and installed on the vehicle 42 and in a use condition, the ladder rack assembly 440 can, for example, can support one or more items thereon, such as equipment, tools, material and recreational items. The ladder rack assembly 440, as will be described below, is relatively strong and can likewise be selectively collapsed or folded and stowed within itself when not in deployed.

The ladder rack assembly 440 is similar to the ladder rack assembly 40, illustrated in FIG. 1, but includes a two piece telescoping adjustment beam assembly structure 460 instead of the three piece beam assembly structure 122 of the ladder rack assembly 40. The description for all other components of the ladder rack assembly 40 will also equally apply to and suffice for this aspect of the ladder rack assembly 440.

The ladder rack assembly 440 includes a first enclosure 462 and a second enclosure 464. The first enclosure 462 and second enclosure 464 are elongate and attachable to the vehicle 42, preferably on a substantially permanent basis, to extend in a direction parallel to a longitudinal central axis of the vehicle 42. Such attachment can be done by any suitable means, such as by fasteners, clamps, adhesive or brazing/welding.

Each of the enclosures 462, 464 is identical to the second closure 64, described above and illustrated in FIG. 19, and no additional detail will be described in-depth. The second closure 464 is a mirror image of the first enclosure 462 and the description for the second closure 464 will equally apply to the first closure 462. The second closure 464 includes the base 82 that is attachable to a component of the vehicle 42, such as a bed of a pickup truck. The cover 48 is attached to the base 82 by a hinge 86. The cover 84 preferably extends for substantially the entire length of the respective enclosure 462, 464. The base 82 is channel shaped and defines a cavity 88 that has an internal dimension or width W1 extending transversely to the length of the base of the enclosures 462, 464.

The cover 84 on a respective enclosure 462, 464 may be pivoted about the hinge 86 between a closed and open position. When the cover 84 is in the closed position relative to the base 82 it protects other components of the ladder rack assembly 440 that may be stored with in the cavity 88 from environmental conditions. The cover 84 can be moved to the open position relative to the base 82 to permit access to other components of the ladder rack assembly 440 that may be stored with in the cavity 88.

The ladder rack assembly 440 (FIG. 20) also includes at least a first rack portion 502 and a substantially identical second rack portion 504. In the illustrated example, the deployed rack portions 502, 504 are spaced apart and separated from each other in a direction along the length of the enclosures 462, 464. The rack portions 502, 504 are located and removably attached at end portions to the enclosures 462, 464. The locations of the rack portions 502, 504 on the enclosures 462, 464 are not limited to the illustrated locations and, instead, may be positioned closer together or farther apart than as illustrated. The rack portions 502, 504 are generally identical in size, shape, structure, construction, materials, etc., such that the following description of an example rack portion generally includes the first rack portion 502 or the second rack portion 504. The rack portions 502, 504 may be made from any suitable material and by any suitable method, such as extruded metal (e.g., steel, aluminum, titanium, etc.), molded or extruded plastic or fiber reinforced plastic, and the like.

Each of the rack portions 502, 504 includes one or more elongated support arms 512 that are identical to the support arms 112, described above. Each of the support arms 512 is removably attachable to a respective one of the enclosures 462, 464. The support arms 512 can be arranged to extend substantially vertically from the vehicle 42. In the illustrated example, the rack portions 502, 504 each include a pair of substantially identical support arms that are spaced apart from each other and extend in a direction transversely upright when attached to the enclosures 462, 464.

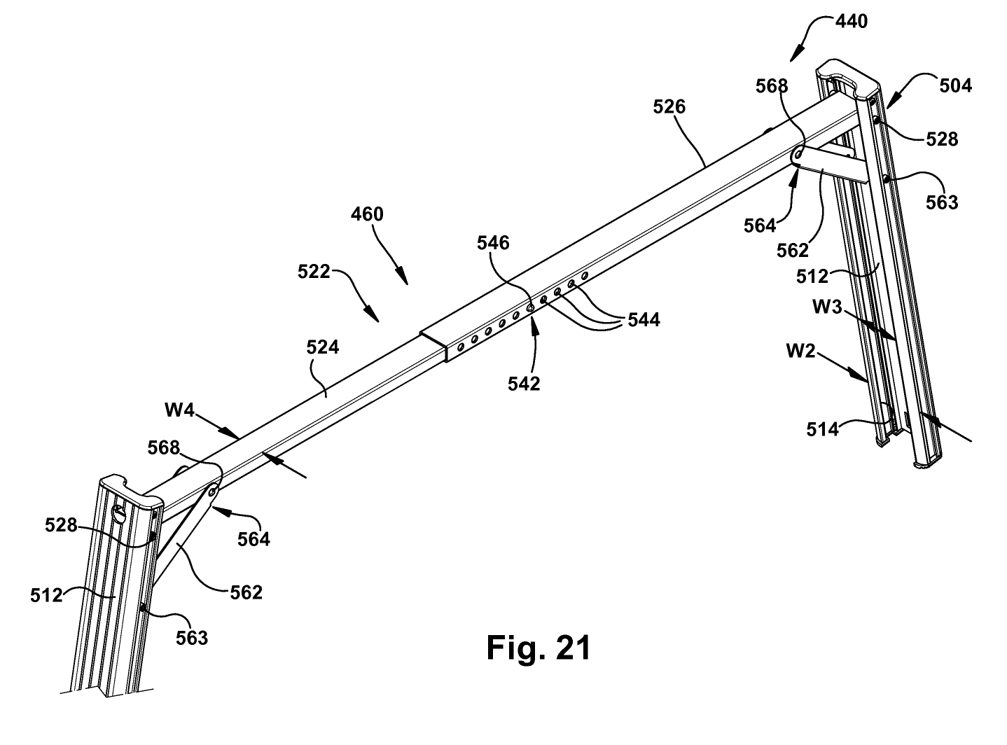

Each of the support arms 512 (best seen in FIG. 21) has an external width W2 taken in a direction transversely to the extent of the support arm. The width W2 of the support arms 512 is larger than the thickness, taken in a direction perpendicular to the width W2. The width W2 of the support arm 512 is less than the width W1 of the enclosures 462, 464, and preferably at least over half the width W1 and more preferably at least seventy percent of width W1. Thus, the support arms 512 are sufficiently rigid/sturdy so as to provide an increased and improved sufficient amount of support for items on the rack portions 502, 504 and not require bracing reinforcement between support arms attached to the same enclosure 462, 464. The support arms 512 are also nestable and stowable within the enclosure 462, 464. The support arm 512 is channel shaped and defines a cavity 514 having an internal width W3. Each support arm 512 may be made from any suitable material and by any suitable method, such as extruded metal (e.g., steel, aluminum, titanium, etc.), molded or extruded plastic or fiber reinforced plastic, and the like.

The rack portions 502, 504 each include an elongated attachment beam 522. The attachment beam 522 extends between respective opposing support arms 512. The attachment beam 522 is intended to extend in a generally horizontal orientation, when the ladder rack assembly 440 is assembled and installed on the vehicle 42, though other orientations/angles/directions are envisioned. The attachment beam 522 is attached to/supported at an end (e.g., upper ends) of the support arms 512 for pivotal movement. In particular, the support arms 512 can attach to/support the attachment beam 522 at an upper end, as viewed in FIG. 21, while a lower end of the support arm 522 is attached to the enclosure 462, 464.

The attachment beam 522 has an external width W4 that is smaller than internal width W3 of the cavity 514 in support arm 512. Thus, the attachment beam 522 can pivot into the cavity 514 in support arm 512 in a nesting manner for storage. The entire structure of the nested attachment beam 522 in the support arm 512 can be stored in the enclosure 462, 464 when it is desired not to employ the ladder rack assembly 440. The width W4 of the attachment beam 522 is larger than the thickness, taken in a direction perpendicular to the width W4.

In the illustrated example, the attachment beam 522 extends between a pair of support arms 512 and includes several different portions, such as two portions. The attachment beam 522 includes a first beam portion 524 and a second adjustable beam portion 526. The first beam portion 524 has a reduced size end portion that extends, in a telescoping relationship, into an open end of the adjustable beam portion 526. The first beam portion 524 is removably and adjustably attachable to the adjustable beam portion 526. In this example, the adjustable beam portion 526 is located on an opposite side of the first beam portion 524. The upper ends of the beam portions 524, 526, as viewed in FIG. 21, are attached for pivotal movement at one end to the respective support arms 512 by suitable structure 528, such as fasteners, shafts or rivets.

The adjustable beam portion 526 and the first beam portion 524 are releasably and adjustably attached in any number of suitable ways. For example, the adjustable beam portions 526 and first beam portion 524 are telescopically attached, such that the adjustable beam portion and first beam portion can move axially with respect to each other. In the illustrated example, the adjustable beam portion 526 telescopically receives the first beam portion 524. The first beam portion 524 and the adjustable beam portion 526 may be made from any suitable material and by any suitable method, such as tubular metal (e.g., steel, aluminum, titanium, etc.), molded or extruded plastic or fiber reinforced plastic, and the like. The first beam portion 524 and the adjustable beam portion 526 have lengths that are selected to fit within the support arms 512 and enclosures 462, 464 for storage.

The adjustable beam portion 526 and first beam portion 524 can be movably adjustable and selectively and releasably attached by a suitable quick release connector structure 542. In the illustrated example, the adjustable beam portion 526 includes adjustment openings 544 that extend at least partially along a length of the adjustable beam portion. The first beam portion 524 includes a spring loaded protrusion 546 that is transversally movable (e.g., can be pushed in and biased outwardly). The protrusion 546 is sized/shaped to be received within one of the adjustment openings 544 of the adjustable beam portion 526 to lock or retain first beam portion 524 and adjustable beam portion in a desired axial relative position.

In operation, the protrusion 546 is received within the desired adjustment opening 544 of the adjustable beam portion 526, such that the adjustable beam portion and first beam portion 524 are substantially non-movable with respect to each other. However, to adjust the relative positions of the adjustable beam portion 526 with respect to the first beam portion 524, the protrusion 546 can be flexed inwardly (e.g., so as to disengage from the adjustment openings 544), with the first beam portion being moved with respect to the adjustable beam portion.

The rack portions 502, 504 each include one or more movable arms or support brackets 562. The support brackets 562 are attached for pivotal movement at one end, the lower end as viewed in FIG. 21, to the respective support arm 512. The support brackets 562 are attached for pivotal movement to the respective support arm 512 by suitable structure 563, such as fasteners, shafts or rivets. The support brackets 562 are also removably attached at an opposite end, the upper end as viewed in FIG. 21, to the to the adjustable beam portions 526. The support brackets 562 provide additional support to the attachment beam 522. In this example, the support brackets 562 can be selectively attached/detached to the attachment beam 522, such that the support brackets can be selectively stowed. The support brackets 562 are sized and shaped, so that they fit or nest between the inside of the support arms 512 and the outside of the respective first beam portion 524 and the adjustable beam portion 526 for compact storage.

The support brackets 562 can be releasably attached in any number of ways to the respective first beam portion 524 and the adjustable beam portion 526, such as by mechanical fasteners, locking means, or the like. In the illustrated example, the support brackets 562 can be releasably attached to the respective first beam portion 524 and the adjustable beam portion 526 by respective quick release connector structure 564. The support brackets 562 include openings. The support brackets 562 include at least one spring loaded protrusion 568 that are transversally movable (e.g., can be pushed in and biased outwardly). The protrusion 568 is sized/shaped to be received within the opening of each support bracket 562.

Each of the closures 462, 464 includes a pair of suitable attachment structures 182, illustrated in FIG. 21. The attachment structures 182 are substantially identical in structure and operation to that described and above illustrated in FIGS. 11a-15 and will not be described further. The attachment structure 582 is fixed to the base 82 of the closure 462 or 464 by suitable mounting structure, such as fasteners or rivets.

A support arm 512 can be received over and attached to the attachment structure 182. The support arm 512 includes openings that are sized/shaped to receive tabs of the attachment structure 182. Once the support arm 512 is positioned on/over the attachment structure 182 and the tabs engage and extend into the openings in the support arm. As such, the support arm 512 is generally limited/prevented from being inadvertently removed from the attachment structure 182.

As described above for enclosures 62, 64, the enclosures 462, 464 can be opened to access the respective rack portions 502, 504. The cover 84 on the enclosure 462 can be opened (e.g., designated by arrows) to access the first rack portion 502. Likewise, the cover 84 on the second enclosure 464 can be opened (e.g., designated by arrows) to access the second rack portion 504.

The rack portions 502, 504 can be removed from the respective enclosures 462, 464. In particular, the first rack portion 502 can be removed by being vertically lifted out of the first enclosure 462. Likewise, the second rack portion 504 can be removed by being vertically lifted out of the second enclosure 464. The rack portions 502, 504 can now be moved and oriented to a pre-attachment position for assembly into a useable structure.

The support arms 512 are moved into an opened position/configuration relative to the respective attachment beams 522. For example, with respect to either of the first rack portion 502 or second rack portion 504, the support arms 512 can be moved/pivoted into an extended position. As the support arm 512 is pivoted, the attachment beam 522 leaves the cavity 514 of the support arm.

The attachment beam 522 can be selectively adjusted in length so as to match a desired width (e.g., distance) across the vehicle (e.g., bed). In particular, the attachment beam 522 can be lengthened or shortened such that the support arms 512 are generally aligned with sides of the vehicle bed. To adjust the length of the attachment beam 522, the protrusion 546 from the first beam portion 524 can be adjusted with respect to the adjustment openings 544 of the adjustable beam portion 526.

The support brackets 562 can be moved upwardly so as to engage the attachment beam 522 to a bracing condition. For example, end portions of the support brackets 562 can be pivoted upwardly with respect to the support arms 512 in a direction towards the attachment beam 522. Each of the support brackets 562 can be attached with respect to the beam portion 524, 526. The support brackets 562, therefore, provide additional support to the attachment beam 522 so as to provide stability to the attachment beam and/or to allow the attachment beam to support a relatively heavier load.

The first rack portion 502 and second rack portion 504 can be attached to attachment structures 182 of the enclosures 462, 464. The first rack portion 502 and second rack portion 504 can be lowered into engagement with the attachment structures 182, such that the rack portions securely attached to the attachment structures of the enclosures 462, 464. When the rack portions 502, 504 are no longer needed for use, the ladder rack assembly 440 can be disassembled in a generally identical, but reverse order of the assembly described above.

The attachment beams 122, 522 can be selectively adjusted in length, taken in a direction along the attachment beams, by a variety of suitable quick release connector mechanisms in addition to the quick release connector structures 142, 542 shown and described above. Several aspects of suitable quick release connector mechanisms will be shown and described below. The quick release connector mechanisms allow releasable and selective length adjustment as well as retaining the established length between the beam portions 124 and 126, 524 and 526.

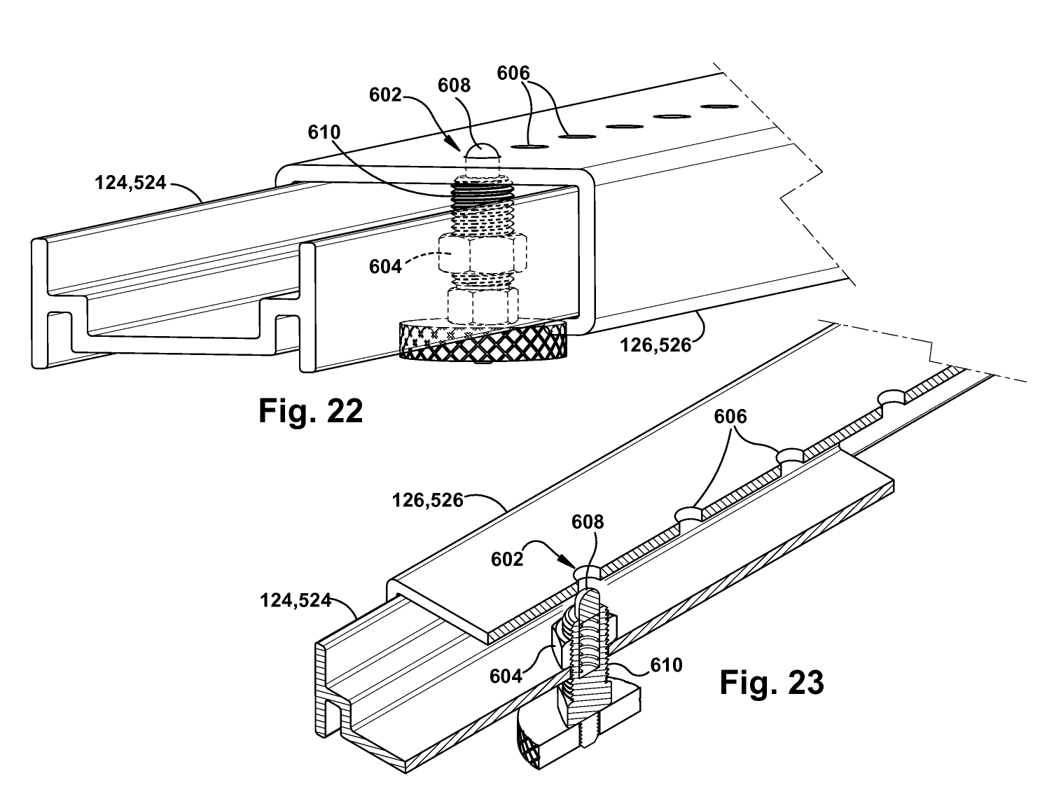

An example of a threaded protrusion version 602 of the quick release connector according to another aspect is illustrated in FIGS. 22 and 23. A threaded fastener component, such as a nut 604 is fixed by suitable means to beam portion 124, 524 such as adhesive or welding/brazing. A plurality of openings 606 are formed in the beam portion 126, 526 and arranged in an array along the extent of the beam portion. A protrusion 608 is biased by a spring towards receipt in and engagement with one of the plurality of openings 606 in the beam portion 126, 526. External threads 610 are arranged along a shaft portion and threateningly engage internal threads on the nut 604. Upon rotation of a knurled thumb wheel, the protrusion 608 can be moved into or out of the opening 606, to allow or prevent movement of the beam portion 124, 524 relative to beam portion 126, 526. The protrusion 608 can also be manually forced out of an opening 606 to allow adjustment of the length of the attachment beam 122, 522. It will be apparent that the nut 604 can be associated with the beam portion 124, 524 and the openings 606 associated with beam portion 126, 526.

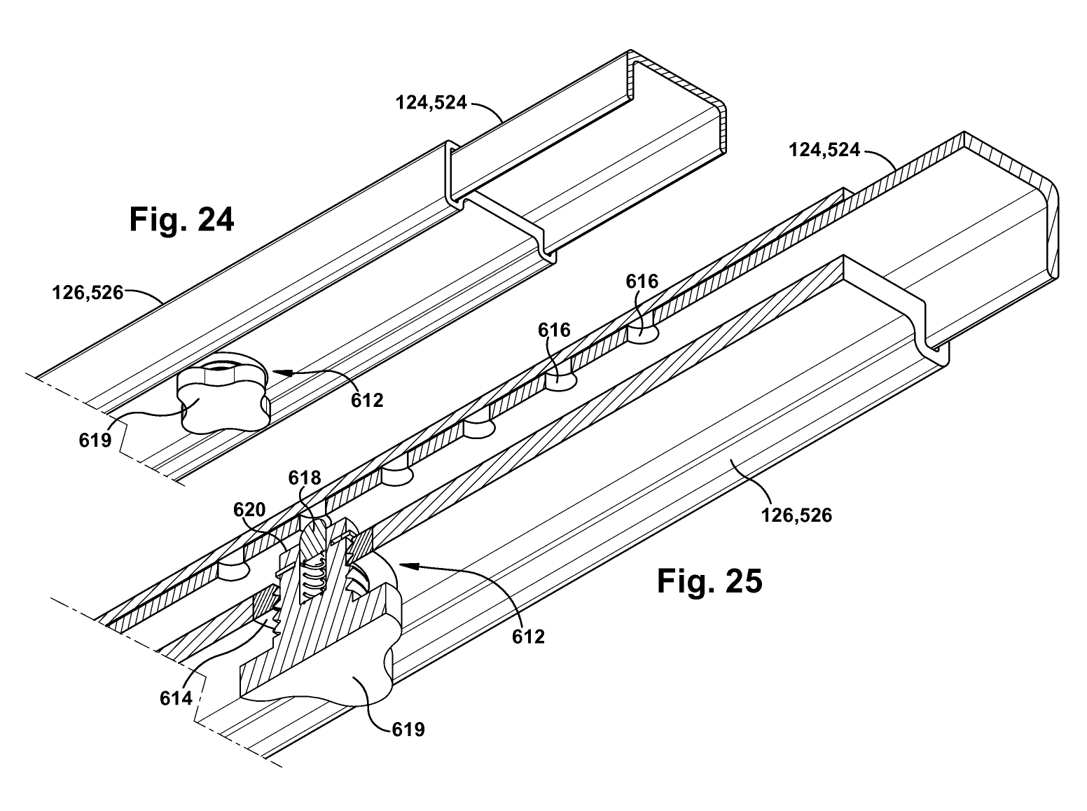

Another example of a threaded protrusion version 612 of the quick release connector according to another aspect is illustrated in FIGS. 24 and 25. A threaded fastener component, such as an insert 614 is fixed by suitable means to beam portion 126, 526 such as adhesive or welding/brazing. A plurality of openings 616 are formed in the beam portion 124, 524 and arranged in an array along the extent of the beam portion. A protrusion 618 is biased by a spring towards receipt in and engagement with one of the plurality of openings 616 in the beam portion 124, 524. Threads 620 are arranged along a shaft portion and threateningly engage threads on the insert 614. Upon rotation of a handle 619, an end portion 620 of the threaded shaft engages the beam portion 124, 524 and the protrusion 618 can be moved into or out of the opening 616, to allow or prevent movement of the beam portion 124, 524 relative to beam portion 126, 526. The protrusion 618 can also be manually forced out of an opening 616 to allow adjustment of the length of the attachment beam 122, 522. It will be apparent that the insert 614 can be associated with the beam portion 124, 524 and the openings 616 associated with beam portion 126, 526.

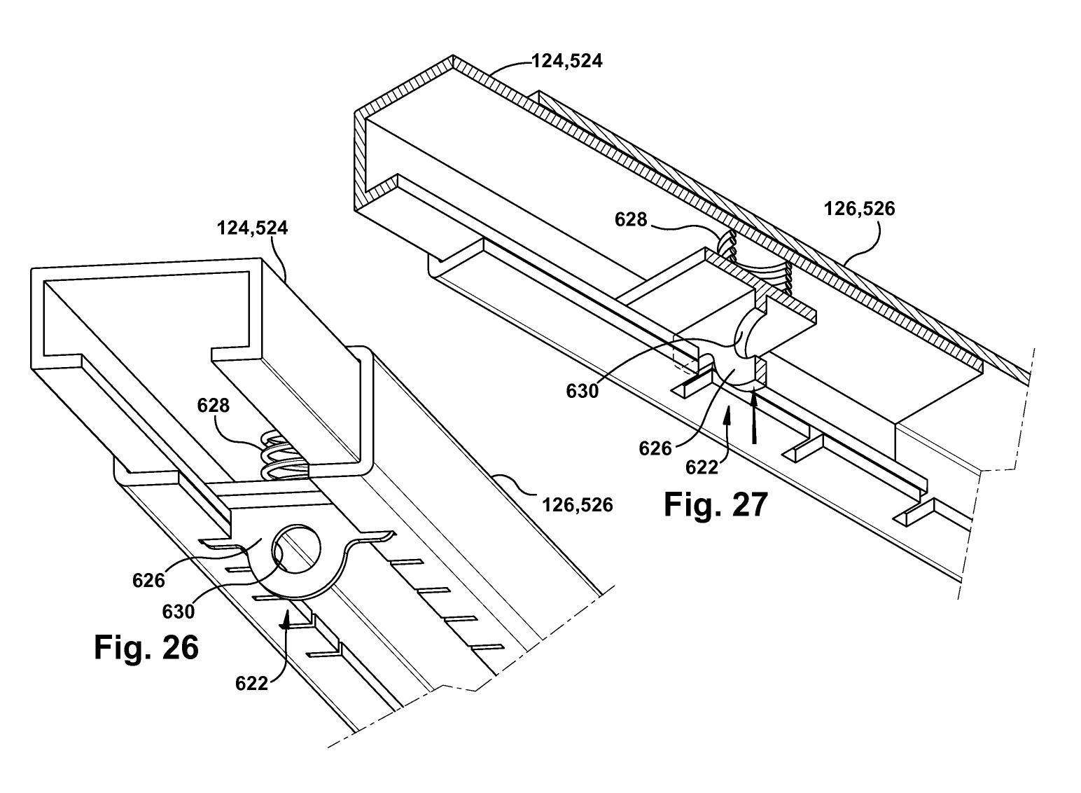

An example of a bar and slot version 622 of the quick release connector according to another aspect is illustrated in FIGS. 26 and 27. A plurality of slots 624 are formed in the beam portion 126, 526 and extend in a direction transverse to the extent of the beam portion. A bar 626 is carried by the beam portion 124, 524. The bar 626 is biased by spring 628 to extend away from the beam portion 124, 524. The bar 626 is reciprocally movable into and out of one of the slots 624. Upon movement of the bar 626 out of a slot 624, the beam portion 124, 524 can be telescopically moved relative to beam portion 126, 526. Upon movement of the bar 626 into a desired slot 624, the beam portion 124, 524 is blocked from moving relative to beam portion 126, 526. It will be apparent that the bar 626 can be associated with beam portion 126, 526 and the slots associated with beam portion 124, 524.

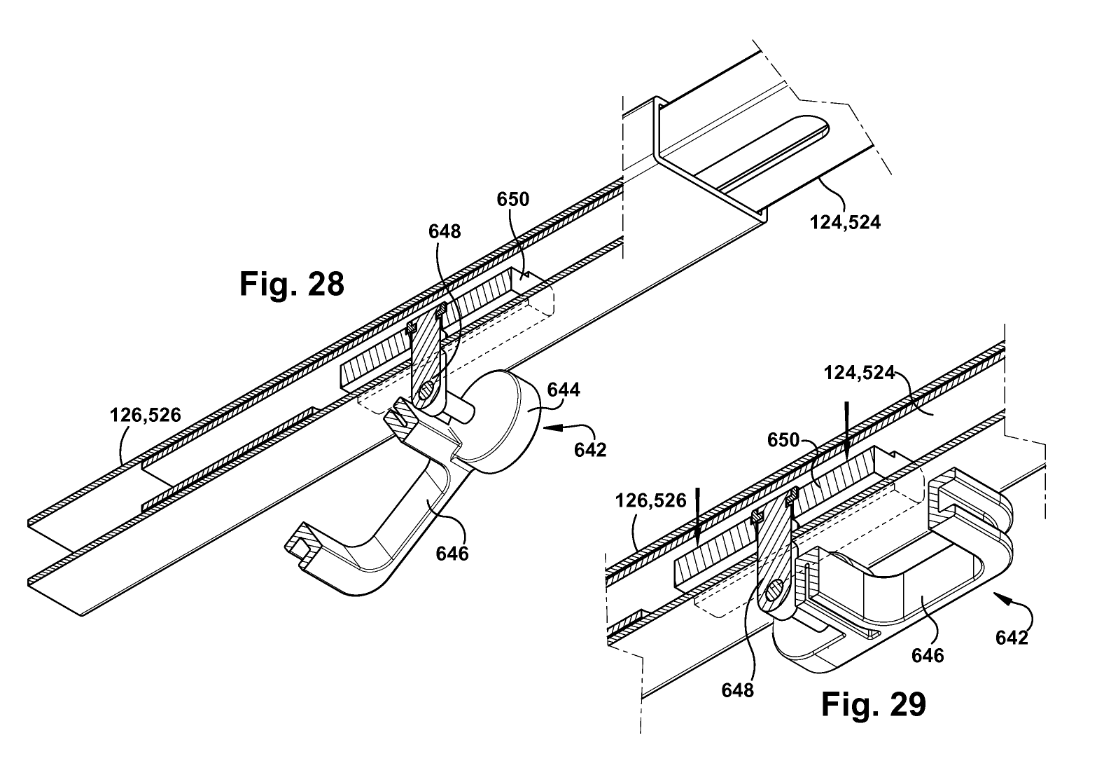

An example of a latch and brake version 642 of the quick release connector according to another aspect is illustrated in FIGS. 28 and 29. A cam 644, handle 646 connected to the cam, a shaft 648 and a friction brake 650 are carried by the beam portion 126, 526. The handle 646 can be pivoted from the position illustrated in FIG. 27 to move the brake 650 into engagement with the beam portion 124, 524. Upon further movement, a clamping force is applied by the brake 650 and cam 644 to opposite sides of radial portions of the attachment beam 124, 524 to retain the attachment beams in a desired relative adjusted length.

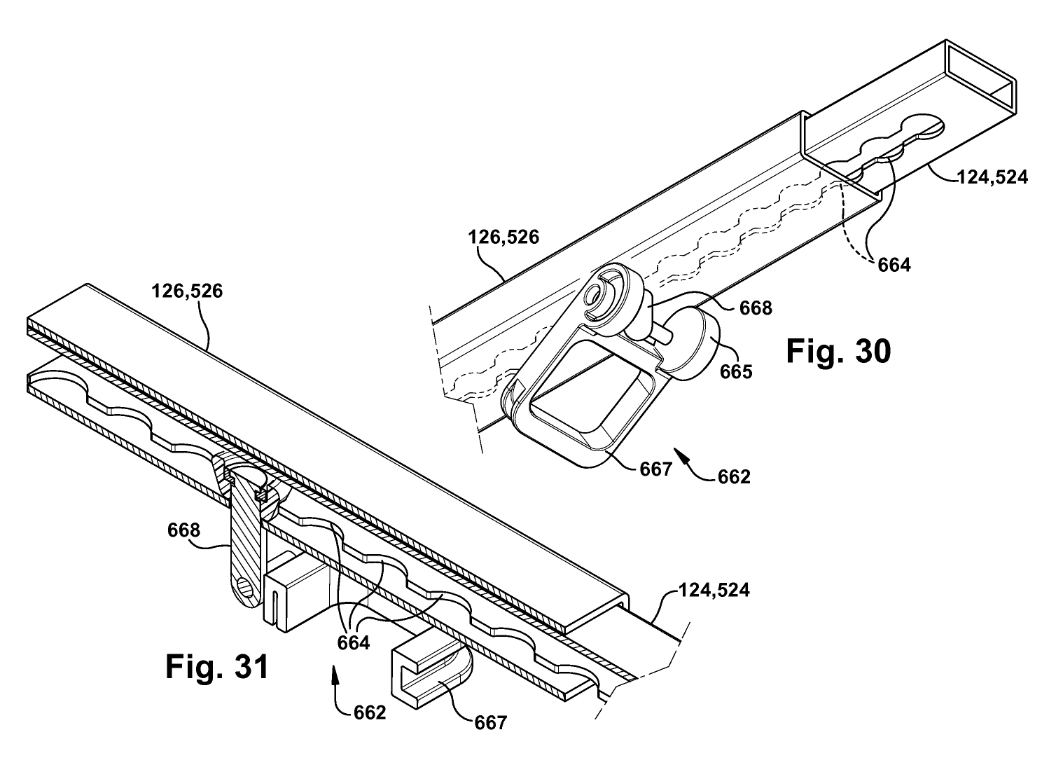

An example of a latch and notch version 662 of the quick release connector according to another aspect is illustrated in FIGS. 30 and 31. A plurality of notches 664 that are interconnected are formed along the length of the beam portion 124, 524. A cam 665 and handle 667 are connected to a shaft 668 with a stop 670. The stop 670 includes a frustoconical surface for engaging the surfaces defining the interconnected notches 664 to apply and clamp opposite sides of the attachment beam portion 124, 524. This interaction retains the attachment beams 122, 522 in a desired discreet relative adjusted length. To release the attachment beams or adjust the length, the handle is moved to the position illustrated in FIG. 29 and this will cause the frustoconical surface 670 to disengage from the interconnected notches 664.

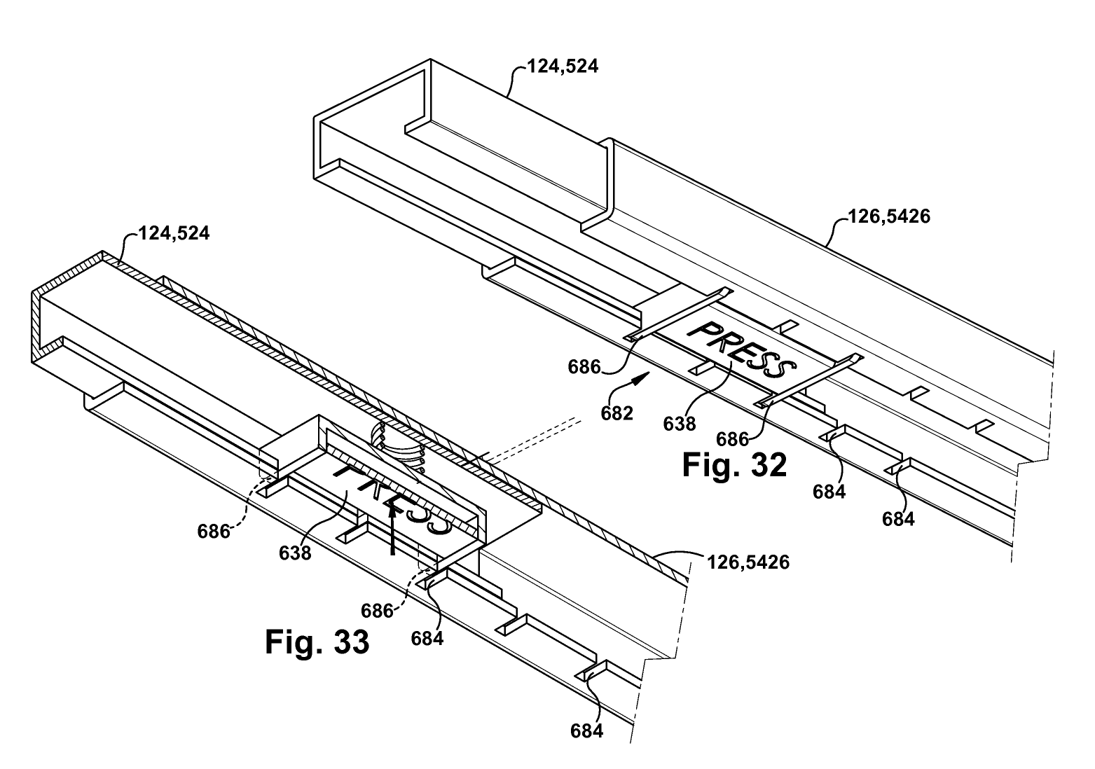

An example of a button bar and slot version 682 of the quick release connector according to another aspect is illustrated in FIGS. 32 and 33. A plurality of transverse notches 684 are formed in the a beam portion 126, 526 and arranged in an axial array along the extent of the attachment beam. Two bars 686 are interconnected by a button 688. He bars are carried by beam portion 124, 524. The bars 686 and the button 688 are biased away from the attachment beam 124, 524 by a spring 690. The button 688 is depressed against the biasing force of the spring 690 in order to disengage the bars 686 from engagement with the slots 684. This will allow adjustment of the length of the attachment beams 122, 512. Upon release of the button 688 the bars 686 can enter spaced apart slots 64 in order to maintain the adjusted length of the attachment beams.

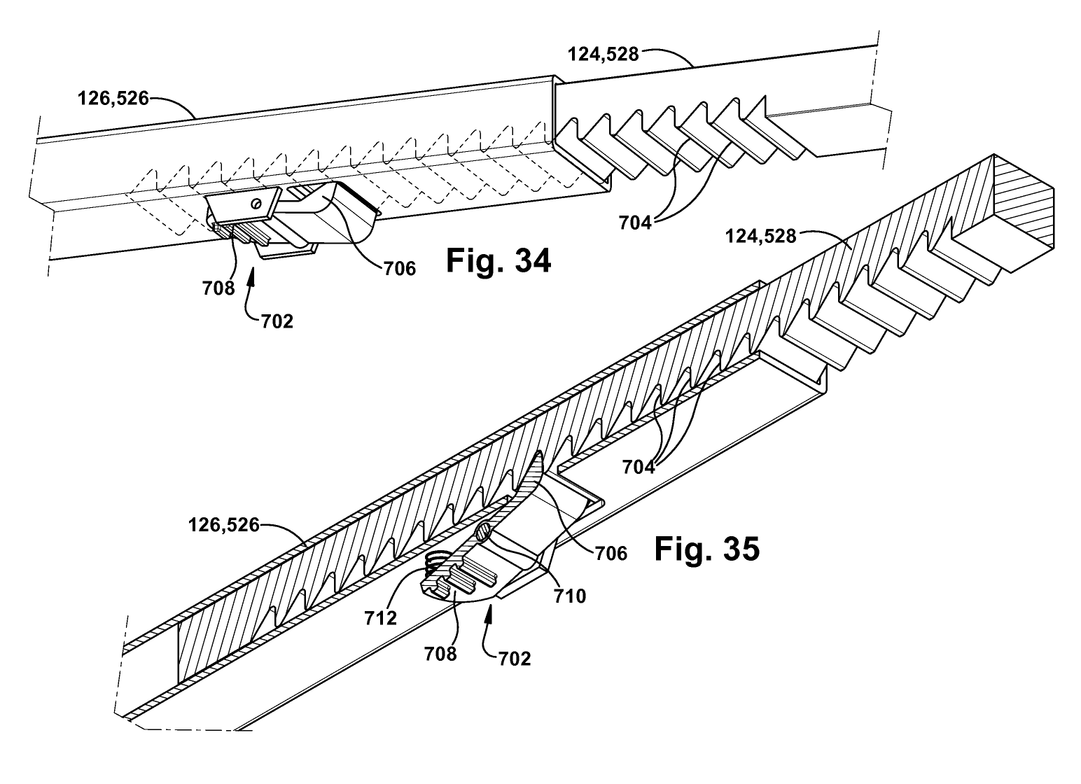

An example of a toothed rack version 702 of the quick release connector according to yet another aspect is illustrated in FIGS. 34 and 35. A plurality of ratcheting teeth 704 are formed in attachment beam portion 124, 524. A stop 706 and handle 708 pivot about a shaft 710 on beam portion 126, 526. The handle and stop 706 are biased by a spring 712 into and engaging position with the ratchet teeth 704. This prevents shortening of the attachment beams 122, 522 but permits lengthening. In order to shorten the overall length of the attachment beams 122, 522, the handle 708 is depressed against the biasing force of the spring 712 and the stop disengages the ratchet teeth 704.

Although the description has been shown and described with respect to one or more embodiments, aspects, applications or implementations, it will occur to those skilled in the art based upon a reading and understanding of this description and the drawings that equivalent alterations and modifications may be made without detracting from the spirit and scope of the embodiments, aspects or implementations in the description. The description and claims are intended to include all such modifications and alterations.

What is claimed is:

1. An apparatus comprising:
an enclosure defining a first cavity; and
a rack assembly receivable within the first cavity of the enclosure for storage, the rack assembly including:
a support arm defining a second cavity, the support arm removably connectable with the enclosure for use and receivable within the first cavity of the enclosure for storage; and
a beam portion connectable with the support arm and receivable in the second cavity of the support arm for storage.

2. The apparatus of claim 1 further including attachment structure associated with the enclosure and located external to the first cavity of the enclosure for removable attachment of the support arm and the enclosure.

3. The apparatus of claim 2 further including a tie down receiver on at least one of the attachment structure and support arm.

4. The apparatus of claim 1 wherein the first cavity has a first internal width and the support arm has second external width at least seventy percent of the first width.

5. The apparatus of claim 1 further including a support bracket for removable attachment between the support arm and beam portion, the support bracket being receivable between the support arm and beam portion for storage.

6. The apparatus of claim 1 further including a second beam portion telescopically receivable within and movable relative to the beam portion.

7. The apparatus of claim 6 further including a quick release connector for selectively maintaining or releasing the relative position between the beam portion and second beam portion.

8. The apparatus of claim 7 wherein the quick release connector is selected from the group comprising a movable button receivable in one of a plurality of openings in one of the beam portion and second beam portion, a movable bar receivable in one of a plurality of slots in one of the beam portion and second beam portion, a cam actuated lever for actuating a locking brake against one of the beam portion and second beam portion, cam actuated lever for moving a pin into and out of one of a plurality of notches in one of the beam portion and second beam portion, and movable lever having a portion for engaging one of a plurality of teeth in one of the beam portion and second beam portion.

9. The apparatus of claim 1 further including a second enclosure defining a third cavity, a second rack assembly receivable within the third cavity of the enclosure for storage, the second rack assembly including a second support arm defining a fourth cavity, the second support arm being removably connectable with the second enclosure for use and receivable within the third cavity of the second enclosure for storage, and a second beam portion connectable with the second support arm and receivable in the fourth cavity of the second support arm for storage, wherein the second beam portion is removably connectable with the beam portion.

10. The apparatus of claim 9 wherein the second beam portion is sized to be telescopically receivable within the beam portion for axial adjustment between the beam portion and second beam portion.

11. An apparatus comprising:
an enclosure defining a first cavity; and
a rack assembly receivable within the first cavity of the enclosure for storage, the rack assembly including:
a support arm defining a second cavity, the support arm connectable with the enclosure and receivable within the first cavity of the enclosure;
a beam portion connectable with the support arm and receivable in the second cavity of the enclosure; and
a second beam portion telescopically receivable within and movable relative to the beam portion.

12. The apparatus of claim 11 further including attachment structure associated with the enclosure and located external to the first cavity of the enclosure for removable attachment of the support arm to the enclosure.

13. The apparatus of claim 12 further including a tie down receiver on at least one of the attachment structure and support arm.

14. The apparatus of claim 11 wherein the first cavity has a first internal width and the support arm has second external width at least eighty percent of the first width.

15. The apparatus of claim 11 further including a support bracket for removable attachment to the support arm and beam portion, the support bracket being storable between the support arm and beam portion.

16. The apparatus of claim 11 further including a quick release connector for selectively maintaining or releasing the relative position between the beam portion and second beam portion.

17. The apparatus of claim 16 wherein the quick release connector is selected from the group comprising a movable button receivable in one of a plurality of openings in one of the beam portion and second beam portion, a movable bar receivable in one of a plurality of slots in one of the beam portion and second beam portion, a cam actuated lever for actuating a locking brake against one of the beam portion and second beam portion, cam actuated lever for moving a pin into and out of one of a plurality of notches in one of the beam portion and second beam portion, and movable lever having a portion for engaging one of a plurality of teeth in one of the beam portion and second beam portion.

18. An apparatus comprising:
an enclosure defining a first cavity;
a rack assembly receivable within the first cavity of the enclosure for storage, the rack assembly including:
a support arm defining a second cavity, the support arm connectable with the enclosure and receivable within the first cavity of the enclosure, the first cavity having a first internal width and the support arm has second external width at least eighty percent of the first width;
a beam portion connectable with the support arm and receivable in the second cavity of the enclosure; and
attachment structure associated with the enclosure and located external to the first cavity of the enclosure for removable attachment of the support arm to the enclosure.

19. The apparatus of claim 18 further including a second beam portion telescopically receivable within and movable relative to the beam portion.

22. The apparatus of claim 19 further including a quick release connector for selectively maintaining or releasing the relative position between the beam portion and second beam portion, wherein the quick release connector is selected from the group comprising a movable button receivable in one of a plurality of openings in one of the beam portion and second beam portion, a movable bar receivable in one of a plurality of slots in one of the beam portion and second beam portion, a cam actuated lever for actuating a locking brake against one of the beam portion and second beam portion, cam actuated lever for moving a pin into and out of one of a plurality of notches in one of the beam portion and second beam portion, and movable lever having a portion for engaging one of a plurality of teeth in one of the beam portion and second beam portion.
